(19) United States
(12) Patent Application Publication
(10) Pub. No.: US 2024/0251154 A1
(43) Pub. Date: Jul. 25, 2024

(54) IMAGE CAPTURE APPARATUS, IMAGE PROCESSING APPARATUS, AND METHOD

(71) Applicant: CANON KABUSHIKI KAISHA, Tokyo (JP)

(72) Inventors: YUMI TAKAO, Chiba (JP); AKIHIRO NISHIO, Kanagawa (JP)

(21) Appl. No.: 18/627,527

(22) Filed: Apr. 5, 2024

Related U.S. Application Data
(63) Continuation of application No. PCT/JP2022/039675, filed on Oct. 25, 2022.

(30) Foreign Application Priority Data
Oct. 27, 2021 (JP) 2021-175904
Oct. 13, 2022 (JP) 2022-165023

(51) Int. Cl. H04N 23/61; G02B 27/00; G02B 27/01; G06V 40/20; H04N 23/63; H04N 23/67

(52) U.S. Cl. CPC H04N 23/61; G02B 27/0093; G02B 27/0172; G06V 40/20; H04N 23/632; H04N 23/676; G02B 2027/0138

(57) ABSTRACT

An image capture apparatus generates image data for display to assist a user to quickly gaze at an intended position or a subject. The image capture apparatus is capable of detecting a position of gaze of a user in an image being displayed. The image capture apparatus, in a case when generating image data for display when the detection of the position of the gaze is on, applies editing processing to the image data to visually emphasize a characteristic area more than another area. The characteristic area is an area of a subject type of which is determined based on a setting of the image capture apparatus.

### CROSS-REFERENCE TO RELATED APPLICATIONS

This application is a Continuation Application of International Patent Application No. PCT/JP2022/039675, filed Oct. 25, 2022, which claims the benefit of Japanese Patent Application No. 2021-175904, filed Oct. 27, 2021, and No. 2022-165023, filed Oct. 13, 2022, each of which is hereby incorporated by reference herein in its entirety.

### BACKGROUND OF THE INVENTION

### Field of the Invention

The present invention relates to an image capture apparatus, an image processing apparatus, and a method.

### Background Art

PTL1 discloses an image capture apparatus that detects a position of gaze of a user in a displayed image and enlarges and displays an area including the position of gaze.

### CITATION LIST

### Patent Literature

PTL1: Japanese Patent Laid-Open No. 2004-215062

According to the technique described in PTL1, the user can easily check whether their gaze is at an intended position in the displayed image. However, the amount of time taken by the user to bring their line-of-sight to the intended position (subject) in the displayed image cannot be reduced.

The present invention has been made in consideration of the aforementioned problems in the related art. An aspect of the present invention provides an image capture apparatus and a method for generating image data for display to assist the user to quickly gaze at an intended position or a subject.

### SUMMARY OF THE INVENTION

According to an aspect of the present invention, there is provided an image capture apparatus, comprising: one or more processors that execute a program stored in a memory and thereby function as: a detecting unit configured to detect a position of gaze of a user in an image displayed by the image capture apparatus; and a generating unit configured to generate image data for the display, wherein the generating unit: for the image data generated when the detecting unit is on, determines a type of a subject of a characteristic area on a basis of a setting of the image capture apparatus; detects a subject of the determined type in the image and determines an area of the subject of the determined type as the characteristic area; and applies editing processing to visually emphasize the characteristic area more than another area, and for the image data generated when the detection unit is off, does not apply editing processing to visually emphasize the characteristic area more than another area.

According to another aspect of the present invention, there is provided a method executed by an image capture apparatus that is capable of detecting a position of gaze of a user in an image displayed, comprising: generating image data for the display, wherein the generating includes, determining a type of a subject of a characteristic area on a basis of a setting of the image capture apparatus, for the image data generated when the detection of the position of gaze is active, detecting a subject of the determined type in the image and determines an area of the subject of the determined type as the characteristic area, and applying editing processing to visually emphasize the characteristic area more than another area, and for the image data generated when the detection of the position of gaze is inactive, not applying editing processing to visually emphasize the characteristic area more than another area.

According to a further aspect of the present invention, there is provided a non-transitory computer-readable medium storing a program that causes, when executed by a computer included in an image capture apparatus, the image capture apparatus comprising: a detecting unit configured to detect a position of gaze of a user in an image displayed by the image capture apparatus; and a generating unit configured to generate image data for the display, wherein the generating unit: for the image data generated when the detecting unit is on, determines a type of a subject of a characteristic area on a basis of a setting of the image capture apparatus; detects a subject of the determined type in the image and determines an area of the subject of the determined type as the characteristic area; and applies editing processing to visually emphasize the characteristic area more than another area, and for the image data generated when the detection unit is off, does not apply editing processing to visually emphasize the characteristic area more than another area.

According to another aspect of the present invention, there is provided an image processing apparatus, comprising: one or more processors that execute a program stored in a memory and there by function as a generating unit configured to generate image data for display on a head-mounted display apparatus, wherein the generating unit generates the image data by applying editing processing to visually emphasize a characteristic area according to a type of a virtual environment provided to a user via the display apparatus more than another area.

According to a further aspect of the present invention, there is provided an image processing method executed by an image processing apparatus, comprising: generating image data for display on a head-mounted display apparatus, wherein the generating includes generating the image data by applying editing processing to visually emphasize a characteristic area according to a type of a virtual environment provided to a user via the display apparatus more than another area.

According to another aspect of the present invention, there is provided a non-transitory computer-readable medium storing a program that causes, when executed by a computer, the computer to function as an image capture apparatus comprising a generating unit configured to generate image data for display on a head-mounted display apparatus, wherein the generating unit generates the image data by applying editing processing to visually emphasize a characteristic area according to a type of a virtual environment provided to a user via the display apparatus more than another area.

Further features of the present invention will become apparent from the following description of exemplary embodiments with reference to the attached drawings.

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a block diagram illustrating the configuration of an image capture device according to an embodiment of the present invention.

FIG. 2A is a diagram illustrating the corresponding relationship between a pupil surface of a pixel of an image capture apparatus and a photoelectric conversion unit according to an embodiment of the present invention.

FIG. 2B is a diagram illustrating the corresponding relationship between a pupil surface of a pixel of an image capture apparatus and a photoelectric conversion unit according to an embodiment of the present invention.

FIG. 3A is a diagram illustrating the configuration of a line-of-sight input unit according to an embodiment of the present invention.

FIG. 3B is a diagram illustrating the configuration of a line-of-sight input unit according to an embodiment of the present invention.

FIG. 4 is a flowchart of a first embodiment of the present invention.

FIG. 5A is a diagram illustrating an example of the external appearance of an image capture apparatus according to an embodiment of the present invention.

FIG. 5B is a diagram illustrating an example of the external appearance of an image capture apparatus according to an embodiment of the present invention.

FIG. 5C is a diagram illustrating an example of the external appearance of an image capture apparatus according to an embodiment of the present invention.

FIG. 6A is a diagram illustrating a first example of image editing of the first embodiment of the present invention.

FIG. 6B is a diagram illustrating the first example of image editing of the first embodiment of the present invention.

FIG. 6C is a diagram illustrating the first example of image editing of the first embodiment of the present invention.

FIG. 6D is a diagram illustrating the first example of image editing of the first embodiment of the present invention.

FIG. 7A is a diagram illustrating a second example of image editing of the first embodiment of the present invention.

FIG. 7B is a diagram illustrating the second example of image editing of the first embodiment of the present invention.

FIG. 7C is a diagram illustrating the second example of image editing of the first embodiment of the present invention.

FIG. 8A is a diagram illustrating an example of the configuration of an image capture apparatus according to a second embodiment of the present invention.

FIG. 8B is a diagram illustrating an example of the configuration of the image capture apparatus according to a second embodiment of the present invention.

FIG. 8C is a diagram illustrating an example of the configuration of the image capture apparatus according to a second embodiment of the present invention.

FIG. 9 is a flowchart of the second embodiment of the present invention.

FIG. 10A is a diagram illustrating a third example of image editing of the second embodiment of the present invention.

FIG. 10B is a diagram illustrating the third example of image editing of the second embodiment of the present invention.

FIG. 10C is a diagram illustrating the third example of image editing of the second embodiment of the present invention.

FIG. 11A is a diagram illustrating a fourth example of image editing of the second embodiment of the present invention.

FIG. 11B is a diagram illustrating the fourth example of image editing of the second embodiment of the present invention.

FIG. 11C is a diagram illustrating the fourth example of image editing of the second embodiment of the present invention.

FIG. 12A is a diagram illustrating an example of a calibration screen presented by an image capture apparatus according to a third embodiment.

FIG. 12B is a diagram illustrating an example of a calibration screen presented by the image capture apparatus according to the third embodiment.

FIG. 12C is a diagram illustrating an example of a calibration screen presented by the image capture apparatus according to the third embodiment.

FIG. 13A is a diagram illustrating an example of a scene appropriate for editing processing according to vision characteristics and an example of editing processing.

FIG. 13B is a diagram illustrating an example of a scene appropriate for editing processing according to vision characteristics and an example of editing processing.

FIG. 14A is a diagram illustrating an example of a scene appropriate for editing processing according to vision characteristics and an example of editing processing.

FIG. 14B is a diagram illustrating an example of a scene appropriate for editing processing according to vision characteristics and an example of editing processing.

FIG. 15A is a diagram illustrating an example of a scene appropriate for editing processing according to vision characteristics and an example of editing processing.

FIG. 15B is a diagram illustrating an example of a scene appropriate for editing processing according to vision characteristics and an example of editing processing.

FIG. 16A is a diagram illustrating an example of a scene appropriate for editing processing according to vision characteristics and an example of editing processing.

FIG. 16B is a diagram illustrating an example of a scene appropriate for editing processing according to vision characteristics and an example of editing processing.

FIG. 17 is a flowchart relating to image data for display generation operations according to the third embodiment.

FIG. 18A is a diagram illustrating an example of a virtual space present in a fourth embodiment.

FIG. 18B is a diagram illustrating an example of a virtual space present in the fourth embodiment.

FIG. 19A is a diagram illustrating an example of display with emphasis according to the fourth embodiment.

FIG. 19B is a diagram illustrating an example of display with emphasis according to the fourth embodiment.

FIG. 20 is a diagram illustrating an example of the relationship between a type of virtual space and a type of subject that can be displayed with emphasis according to the fourth embodiment.

FIG. 21A is a diagram illustrating an example of a GUI for selecting a main subject type according to the fourth embodiment.

FIG. 21B is a diagram illustrating an example of a GUI for selecting a main subject type according to the fourth embodiment.

FIG. 22 is a diagram illustrating an example of metadata as image data according to the fourth embodiment.

FIG. 23A is a diagram illustrating an example of an indicator displayed together with a virtual space image according to the fourth embodiment.

FIG. 23B is a diagram illustrating an example of an indicator displayed together with a virtual space image according to the fourth embodiment.

FIG. 24A is a diagram illustrating an example of a display system according to a fifth embodiment.

FIG. 24B is a flowchart illustrating an example of the operations of the display system according to the fifth embodiment.

FIG. 24C is a flowchart illustrating an example of the operations of the display system according to the fifth embodiment.

FIG. 25 is a block diagram illustrating an example of the functional configuration of a computing device that can be used as a server according to the fifth embodiment.

FIG. 26 is a diagram illustrating an example of a display area according to the fifth embodiment.

FIG. 27A is a diagram illustrating another example of a display system according to the fifth embodiment.

FIG. 27B is a flowchart illustrating another example of the operations of the display system according to the fifth embodiment.

FIG. 27C is a flowchart illustrating another example of the operations of the display system according to the fifth embodiment.

FIG. 28 is a diagram illustrating an example of the configuration of a camera used according to the fifth embodiment.

### DESCRIPTION OF THE EMBODIMENTS

Hereafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

In the embodiments described below, the present invention is implemented as an image capture apparatus such as a digital camera. However, the present invention can be implemented as any electronic device that can detect a position of gaze on a display screen. Examples of such an electronic apparatus include image capture apparatuses as well as computer devices (personal computers, tablet computers, media players, PDAs, and the like), mobile phones, smartphones, game consoles, robots, in-vehicle devices, and the like. These are examples, and the present invention can be implemented as other electronic devices.

### First Embodiment

### Description of Image Capture Apparatus Configuration

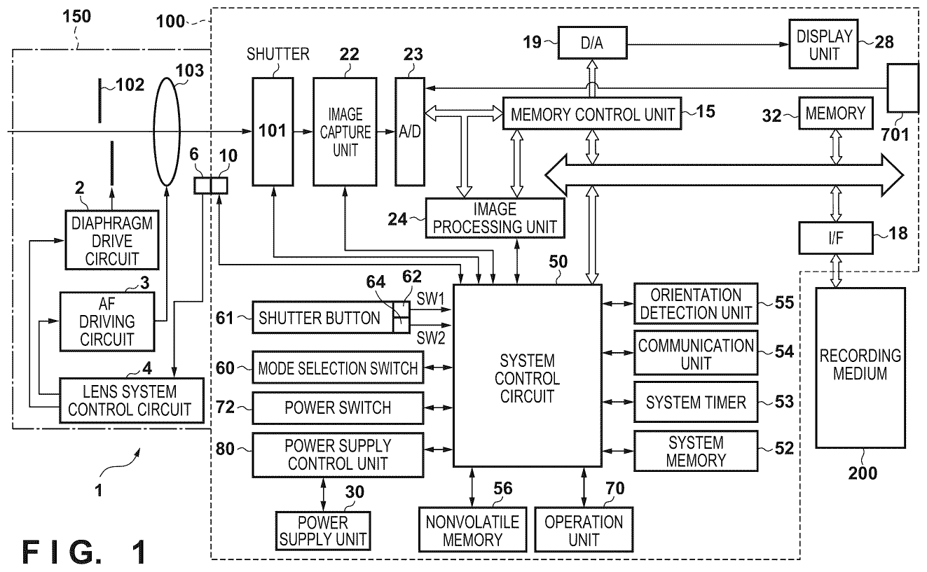

FIG. 1 is a block diagram illustrating an example of the functional configuration of an image capture apparatus 1 representing an example of an image processing apparatus according to this embodiment. The image capture apparatus 1 includes a body 100 and a lens unit 150. In this example, the lens unit 150 is a replaceable lens unit that can be installed and removed from the body 100, but the lens unit 150 may be integrally formed with the body 100.

The lens unit 150 and the body 100 are mechanically and electrically connected via a lens mount. Communication terminal 6 and 10 provided on the lens mount are contacts that electrically connect the lens unit 150 and the body 100. A lens unit control circuit 4 and a system control circuit 50 can communicate via the communication terminal 6 and 10. Also, the power required for the operation of the lens unit 150 is supplied from the body 100 to the lens unit 150 via the communication terminal 6 and 10.

The lens unit 150 forms an image capture optical system that forms an optical image of the subject on the imaging plane of an image capture unit 22. The lens unit 150 includes a diaphragm 102 and a plurality of lens 103 including a focus lens. The diaphragm 102 is driven by a diaphragm drive circuit 2, and the focus lens is driven by an AF drive circuit 3. The operations of the diaphragm drive circuit 2 and the AF drive circuit 3 are controlled by a lens system control circuit 4 in accordance with an instruction from the system control circuit 50.

A focal-plane shutter 101 (hereinafter referred to simply as shutter 101) is driven by the control of the system control circuit 50. The system control circuit 50 controls the operations of the shutter 101 to expose the image capture unit 22 in accordance with image capture conditions at the still image capturing time.

The image capture unit 22 is an image sensor including a plurality of pixels in a two-dimensional array. The image capture unit 22 converts an optical image formed on the imaging plane into a pixel signal group (analog image signal) via a photoelectric conversion unit included in each pixel. The image capture unit 22 may be a CCD image sensor or a CMOS image sensor, for example.

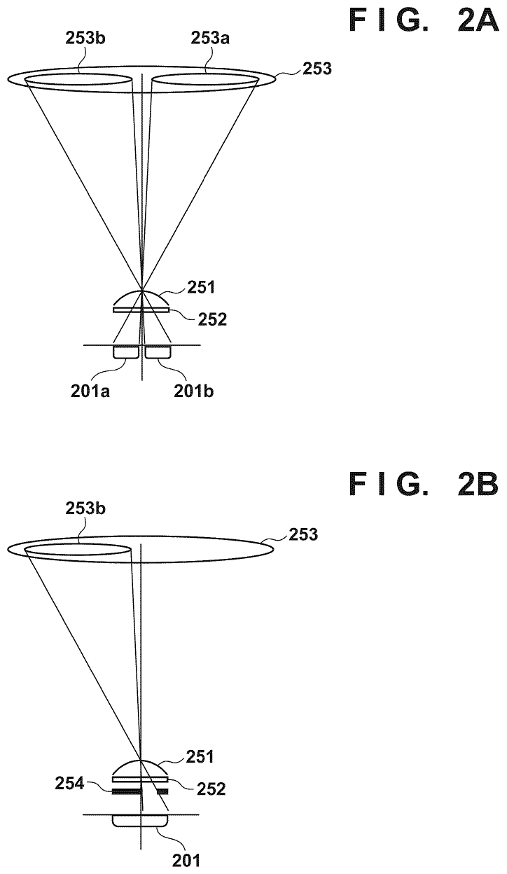

The image capture unit 22 according to the present embodiment can generate a pair of image signals to be used in automatic focus detection of the phase detection method (hereinafter referred to as phase detection AF). FIGS. 2A and 2B illustrate the corresponding relationship between pupil surface of the lens unit 150 and the photoelectric conversion unit of the pixel included in the image capture unit 22. FIG. 2A illustrates an example of a configuration in which the pixel includes a plurality (two in this example) photoelectric conversion units 201a and 201b, and FIG. 2B illustrates an example of a configuration in which the pixel includes one photoelectric conversion unit 201.

In the pixel, one micro lens 251 and one color filter 252 are provided. The color of the color filter 252 is different per pixel, and the colors are arranged in a preset pattern. In this example, the color filter 252 is arranged using a primary color Bayer pattern. In this case, the colors of the color filter 252 included in each pixel are red (R), green (G), and blue (B).

In the configuration of FIG. 2A, the light entering the pixel from an area 253a of a pupil surface 253 is incident on the photoelectric conversion unit 201a, and the light entering the pixel from an area 253b is incident on the photoelectric conversion unit 201b. Regarding the plurality of pixels, phase detection AF can be performed by using a signal group obtained from the photoelectric conversion unit 201a and a signal group obtained from the photoelectric conversion unit 201b as a pair of image signals.

In a case where the signals obtained by the photoelectric conversion units 201a and 201b are treated separately, each signal functions as a focus detection signal. On the other hand, in a case where the signals obtained by the photoelectric conversion units 201a and 201b of the same pixel are treated collectively (added together), the summed signal functions as a pixel signal. Accordingly, a pixel with the configuration of FIG. 2A functions as both a pixel for focus detection and a pixel for image capture. All of the pixels in the image capture unit 22 have the configuration illustrated in FIG. 2A.

FIG. 2B illustrates an example configuration of a dedicated pixel for focus detection. The pixel illustrated in FIG. 2B is provided with a light shielding mask 254 between the color filter 252 and the photoelectric conversion unit 201. The light shielding mask 254 restricts the light incident on the photoelectric conversion unit 201. Here, the light shielding mask 254 includes an opening portion to allow only the light from the area 253b of the pupil surface 253 to be incident on the photoelectric conversion unit 201. Accordingly, the pixel is essentially identical to a state in which only the photoelectric conversion unit 201b of FIG. 2A is provided. In a similar manner, by using a configuration including the opening portion of the light shielding mask 254 in which only the light from the area 253a of the pupil surface 253 is incident on the photoelectric conversion unit 201, the pixel can be made essentially identical to a state in which only the photoelectric conversion unit 201a of FIG. 2A is provided. With a plurality of pairs of these two types of pixels being arranged in the image capture unit 22, a signal pair for phase detection AF can be generated.

Note that automatic focus detection of a contrast-detection method (hereinafter referred to as contrast AF) may be used instead of or in combination with the phase detection AF. In a case where only contrast AF is used, the pixel can have the configuration of FIG. 2B excluding the light shielding mask 254.

An A/D converter 23 converts an analog image signal output from the image capture unit 22 into a digital image signal. In a case where the image capture unit 22 can output digital image signals, the A/D converter 23 can be omitted.

An image processing unit 24 applies a predetermined image processing to the digital image signal from the A/D converter 23 or a memory control unit 15 and generates a signal or image data according to the application, obtains and/or generates various information, and the like. The image processing unit 24 may be, for example, dedicated hardware such as an ASIC designed to realize a specific function or may be configured to realize a specific function via a programmable processor such as a DSP executing software.

Here, the image processing applied by the image processing unit 24 includes preprocessing, color interpolation processing, correction processing, detection processing, data modification processing, evaluation value calculation processing, special effects processing, and the like. The preprocessing includes signal amplification, reference level adjustment, defective pixel correction, and the like. The color interpolation processing is processing for interpolating values of color components not obtained when shooting, and is also referred to as demosaicing processing or synchronization processing. The correction processing includes white balance adjustment, gradation correction (gamma processing), processing for correcting the effects of optical aberration or vignetting of the lens 103, processing for correcting color, and the like. The detection processing includes processing for detecting a feature area (for example, a face area or a human body area) or movement thereof, processing for recognizing a person, and the like. The data modification processing includes combining processing, scaling processing, encoding and decoding processing, header information generation processing, and the like. The evaluation value calculation processing includes processing for generating signals or evaluation values that are used in automatic focus detection (AF), processing for calculating evaluation values that are used in automatic exposure control (AE), and the like. Special effects processing includes processing for adding blurring, changing color tone, relighting processing, editing processing to be applied when the position of gaze detection described below is on, and the like. Note that these are examples of the image processing that can be applied by the image processing unit 24, and are not intended to limit the image processing applied by the image processing unit 24.

Next, specific examples of characteristic area detection processing will be described. The image processing unit 24 applies a horizontal and vertical band-pass filter to the image data for detection (for example, data of a live view image) and extracts the edge components. Thereafter, the image processing unit 24 applies matching processing using a pre-prepared template to the edge components according to the type of the characteristic area detected and detects an image area similar to the template. For example, in a case where a human face area is detected as a characteristic area, the image processing unit 24 applies matching processing using a template of a face part (for example, eyes, nose, mouth, and ears).

Using matching processing, an area candidate group of eyes, nose, mouth, and ears is detected. The image processing unit 24 narrows down the eye candidate group other eye candidates and to those which satisfy a preset condition (for example, distance between two eyes, inclination, and the like). Then, the image processing unit 24 associates together other parts (nose, mouth, and ears) that satisfy a positional relationship with the narrowed-down eye candidate group. The image processing unit 24 applies a preset non-face condition filter and excludes combinations of parts that do not correspond to a face to detect face areas. The image processing unit 24 outputs the total number of detected face areas and information (position, size, detection reliability, and the like) on each face area to the system control circuit 50. The system control circuit 50 stores the characteristic area information obtained from the image processing unit 24 in a system memory 52.

Note that the method for detecting a human face area described above is merely an example, and any other known method such as methods using machine learning can be used. Also, characteristic areas of not only human faces but other types may be detected, with examples including a human torso, limbs, an animal face, a landmark, characters, a vehicle, an aircraft, a railway vehicle, and the like.

The detected characteristic area can be used to set a focus detection area, for example. For example, a main face area can be determined from the detected face area, and a focus detection area can be set in the main face area. Accordingly, AF can be executed by focusing on the face area in the area to be captured. Note that the main face area may be selected by the user.

Output data from the A/D converter 23 is stored in a memory 32 via the image processing unit 24 and the memory control unit 15 or via only the memory control unit 15. The memory 32 is used as a buffer memory for still image data and moving image data, working memory for the image processing unit 24, video memory for a display unit 28, and the like.

A D/A converter 19 converts image data for display stored in the video memory area of the memory 32 into an analog signal and supplies the analog signal to the display unit 28. The display unit 28 performs display corresponding to the analog signal from the D/A converter 19 on a display device such as a liquid crystal display or the like.

The display unit 28 can be made to function as an electronic viewfinder (EVF) by continuously generating and displaying image data for display while capturing video. An image that is displayed to make the display unit 28 function as an EVF is referred to as a through-the-lens image or a live view image. Note that the display unit 28 may be disposed inside the body 100 so that it is observed through an eyepiece unit or disposed on the casing surface (for example, back surface) of the body 100 or both.

In the present embodiment, to detect the position of gaze of the user, the display unit 28 is at least disposed inside the body 100.

A non-volatile memory 56 is an electrically rewritable memory such as an EEPROM, for example. The non-volatile memory 56 stores a program executable by the system control circuit 50, various setting values, GUI data, and the like.

The system control circuit 50 includes one or more processors (also referred to as CPU, MPU, or the like) that can execute programs. The function of the image capture apparatus 1 is implemented by the system control circuit 50 loading a program stored in the non-volatile memory 56 onto the system memory 52 and executing the program via the processor.

The system memory 52 is used for storing programs executed by the system control circuit 50 and constants, variables, and the like used in programs when executed.

A system timer 53 measures the time used in various controls, the time of an internal clock, and the like.

A power switch 72 is an operation member for switching the power of the image capture apparatus 1 on and off.

A mode selection switch 60, a first shutter switch 62, a second shutter switch 64, and the operation unit 70 are operation members for inputting instructions to the system control circuit 50.

The mode selection switch 60 switches the operation mode of the system control circuit 50 to any one of a still image recording mode, a video capturing mode, a playback mode, or the like. Modes included in the still image recording mode are an automatic image capturing mode, an automatic scene determination mode, a manual mode, an aperture priority mode (Av mode), and a shutter speed priority mode (Tv mode). Also, various types of scene modes, which include image capturing settings specific to respective image capturing scenes, a program AE mode, and custom modes are also included. One of the modes included in a menu button can be directly switched to via the mode selection switch 60. Alternatively, after switching to the menu button via the mode selection switch 60, one of the modes included in the menu button may be switched to using another operation member. In a similar manner, the video capturing mode may include a plurality of modes.

The first shutter switch 62 is turned on with a half-stroke of a shutter button 61 and generates a first shutter switch signal SW1. The system control circuit 50 recognizes the first shutter switch signal SW1 as a still image capture preparation instruction and starts image capture preparation operations. In the image capture preparation operations, for example, AF processing, automatic exposure control (AE) processing, auto white balance (AWB) processing, EF (pre-flash emission) processing, and the like are included, but none of these are required and other processing may be included.

The second shutter switch 64 is turned on with a full-stroke of the shutter button 61 and generates a second shutter switch signal SW2. The system control circuit 50 recognizes the second shutter switch signal SW2 as a still image capture instruction and executes image capture processing and recording processing.

The operation unit 70 is a generic term for operation members other than the shutter button 61, the mode selection switch 60, and the power switch 72. The operation unit 70, for example, includes a directional key, a set (execute) button, a menu button, a video capture button, and the like. Note that in a case where the display unit 28 is a touch display, software keys implemented by a display and touch operations may also form the operation unit 70. When the menu button is operated, the system control circuit 50, a menu screen operable via the directional key and the set button is displayed on the display unit 28. The user can change the settings of the image capture apparatus 1 by operating the software keys and the menu screen.

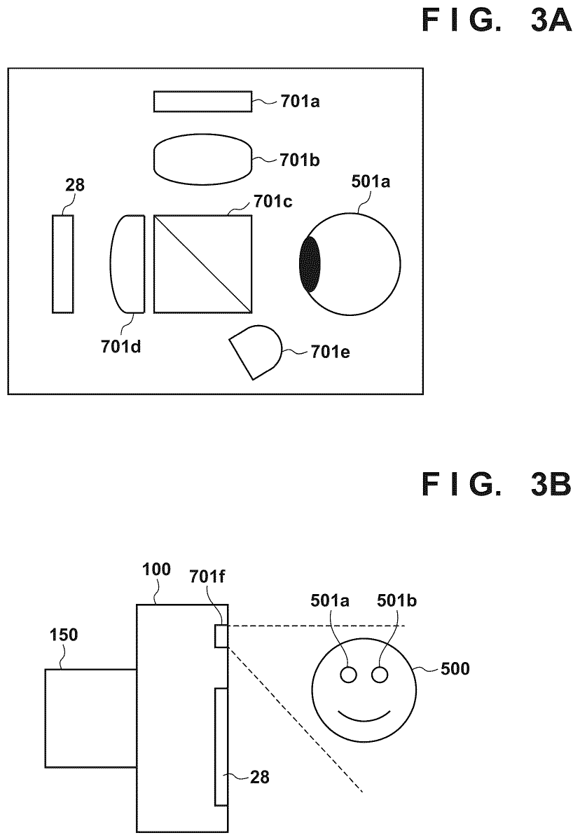

FIG. 3A is a side view schematically illustrating an example configuration of a line-of-sight input unit 701. The line-of-sight input unit 701 is a unit that obtains an image (image for line-of-sight detection) for detecting the rotation angle of the optical axis of an eyeball 501a of a user gazing at the display unit 28 provided inside the body 100 through an eyepiece unit.

Processing is executed on an image for line-of-sight detection at the image processing unit 24, and the rotation angle of the optical axis of the eyeball 501a is detected. Since the rotation angle represents the direction of the line-of-sight, the position of gaze on the display unit 28 can be deduced on the basis of the rotation angle and a preset distance from the eyeball 501a to the display unit 28. Note that in deducing the position of gaze, user-specific information obtained via a calibration operation performed in advance may be taken into account. Deducing the position of gaze may be executed by the image processing unit 24 or by the system control circuit 50. The line-of-sight input unit 701 and the image processing unit 24 (or the system control circuit 50) form detecting means that can detect the position of gaze of a user in an image displayed on the display unit 28 by the image capture apparatus 1.

The image displayed on the display unit 28 can be seen by the user through an eyepiece lens 701d and a dichroic mirror 701c. An illumination light source 701e emits infrared light in a direction outside of the casing through the eyepiece unit. The infrared light reflected at the eyeball 501a is incident on the dichroic mirror 701c. The dichroic mirror 701c reflects the incident infrared light upward. A light-receiving lens 701b and an image sensor 701a are disposed above the dichroic mirror 701c. The image sensor 701a captures an infrared light image formed by the light-receiving lens 701b. The image sensor 701a may be a monochrome image sensor.

The image sensor 701a outputs an analog image signal obtained via image capture to the A/D converter 23. The A/D converter 23 outputs the obtained digital image signal to the image processing unit 24. The image processing unit 24 detects an eyeball image from the image data and further detects a pupil area in the eyeball image. The image processing unit 24 calculates the rotation angle (line-of-sight direction) of the eyeball from the position of the pupil area in the eyeball image. The processing to detect the line-of-sight direction from the image including the eyeball image can be implemented using a known method.

FIG. 3B is a side view schematically illustrating an example configuration of the line-of-sight input unit 701 in a case where the display unit 28 is provided on the back surface of the image capture apparatus 1. In this case also, infrared light is emitted in a direction where a face 500 of a user watching the display unit 28 is assumed to be. Then, by performing image capture using a camera 701f provided on the back surface of the image capture apparatus 1, an infrared image of the face 500 of the user is obtained. By detecting the pupil area from an image of the eyeball 501a and/or an eyeball 501b, the line-of-sight direction is detected.

Note that the configuration of the line-of-sight input unit 701 and the processing of the image processing unit 24 (or the system control circuit 50) are not particularly limited, and any other configuration and processing can be used as long as ultimately the position of gaze on the display unit 28 can be detected.

Returning to FIG. 1, a power supply control unit 80 is constituted by a battery detection circuit, a DC-DC converter, a switch circuit that switches current-carrying blocks, and the like. In a case where a power supply unit 30 is a battery, the power supply control unit 80 detects the presence/absence of installed batteries, the type, and the remaining amount. Also, the power supply control unit 80 controls the DC-DC converter on the basis of the detection results and an instruction from the system control circuit 50 and supplies the required voltages to various components including a recording medium 200 at the required time.

The power supply unit 30 includes at least one of a primary battery, such as an alkaline battery and a lithium battery, a secondary battery such as a NiCd battery, a NiMH battery, and a Li battery, and/or an AC adapter.

A recording medium I/F 18 is an interface with the recording medium 200, such as a memory card or a hard disk. The recording medium 200 may be detachable or not-detachable. The recording medium 200 is a storage destination for image data obtained by image capture.

A communication unit 54 transmits and receives image signals and audio signals with an external apparatus connected via a wireless or wired connection. The communication unit 54 supports one or more communication standards including wireless LAN (Local Area Network), USB (Universal Serial Bus), and the like. The system control circuit 50 can transmit image data (including a through-the-lens image) obtained via image capture by the image capture unit 22 and image data recorded on the recording medium 200 to the external apparatus via the communication unit 54. Also, the system control circuit 50 can receive image data and various other types of information from an external device via the communication unit 54.

An orientation detection unit 55 detects the orientation of the image capture apparatus 1 with respect to the gravity direction. On the basis of the orientation detected by the orientation detection unit 55, whether the image capture apparatus 1 at the time of image capture has a horizontal orientation or a vertical orientation can be determined. The system control circuit 50 can add the orientation of the image capture apparatus 1 at the time of image capture to an image data file, can align the orientation of images for recording, and the like. An acceleration sensor, a gyro sensor, or the like can be used as the orientation detection unit 55.

### Position of Gaze Detection Operation

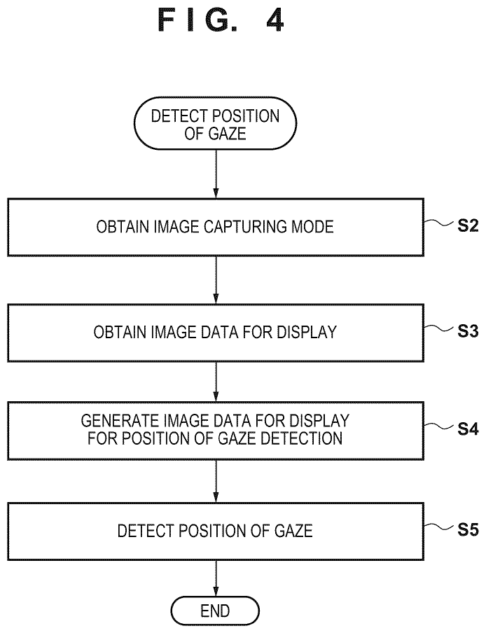

FIG. 4 is a flowchart relating to the position of gaze detection operation of the image capture apparatus 1. The position of gaze detection operation is executed in the case of the line-of-sight detection function being set to on. Also, the position of gaze detection operation can be executed in parallel with the live view display operation.

In S2, the system control circuit 50 obtains the currently set image capturing mode. The image capturing mode can be set via the mode selection switch 60. Note that in a case where a scene selection mode is set using the mode selection switch 60, the types of scene set in the scene selection mode is also treated as an image capturing mode.

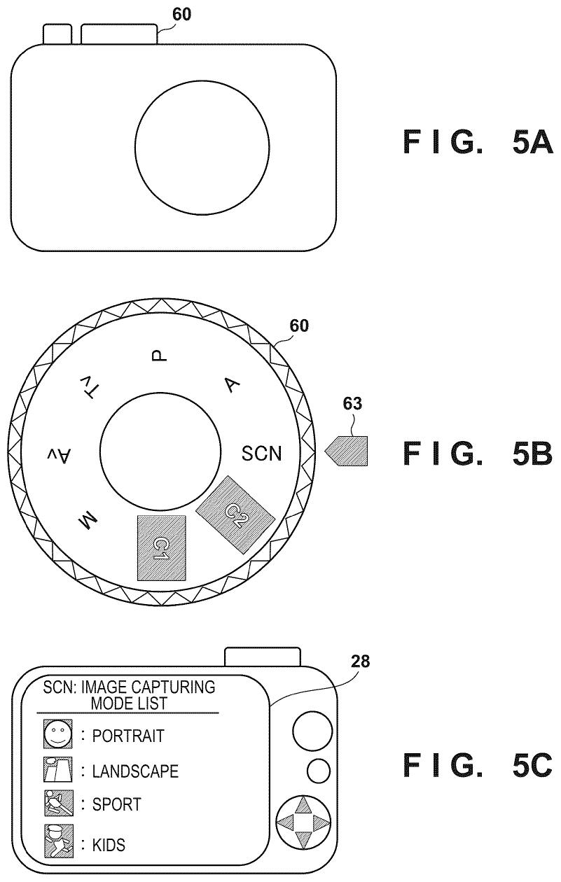

FIGS. 5A to 5C are diagrams illustrating examples of the external appearance of the image capture apparatus 1. FIG. 5A illustrates an example layout for the mode selection switch 60. FIG. 5B is a top view of the mode selection switch 60 and illustrates examples of selectable image capturing modes. For example, Tv represents a shutter speed priority mode, Av represents an F-number priority mode, M represents a manual setting mode, P represents a program mode, SCN represents a scene selection mode. By rotating the mode selection switch 60 to bring the characters of the desired image capturing mode to the position of a mark 63, the image capturing mode can be set to the desired image capturing mode. FIG. 5B illustrates a state in which the scene selection mode is selected.

The scene selection mode is an image capturing mode for taking an image of a specific scene or subject. Thus, in the scene selection mode, the type of scene or subject needs to be set. The system control circuit 50 sets the image capture conditions (shutter speed, f-number, sensitivity, and the like) and the AF mode as appropriate for the set type of scene or subject.

In the present embodiment, the type of scene or subject in the scene selection mode can be set by operating the menu screen displayed on the display unit 28 as illustrated in FIG. 5C. In this example, portrait, landscape, kids, and sports can be selected, but more options may be available. As described above, in the scene selection mode, the set type of scene or subject is treated as an image capturing mode.

In S3, the system control circuit 50 obtains image data for display. The system control circuit 50 reads out image data for live view display to be displayed that is stored in the video memory area of the memory 32 and supplies the image data to the image processing unit 24.

In S4, the image processing unit 24, functioning as a generating unit, applies editing processing to the image data for display supplied from the system control circuit 50 and generates image data for display for position of gaze detection. Then, the image processing unit 24 stores the generated image data for display in the video memory area of the memory 32. Note that here in S3, the image data for display obtained from the video memory area is edited. However, when the image data for display is generated by the image processing unit 24, editing processing may be applied and image data for display for position of gaze detection may be generated from the start.

Next, some examples of editing processing that is applied by the image processing unit 24 for position of gaze detection will be described. The editing processing that is applied for position of gaze detection is editing processing in which the characteristic area determined on the basis of the setting information (in this example, the image capturing mode) of the image capture apparatus 1 is visually emphasized more than other areas. With this editing processing, it is easier for the user to quickly match their line-of-sight with a desired subject. Depending on the setting information, what kind of characteristic information to detect, the parameter required to detect the characteristic information, and the like are prestored in the non-volatile memory 56 for each piece of setting information, for example. For example, the type of main subject corresponding to a specific scene or a template or parameter for detecting the characteristic area of the main subject can be associated with and prestored with the image capturing mode for capturing an image of the specific scene.

### First Example

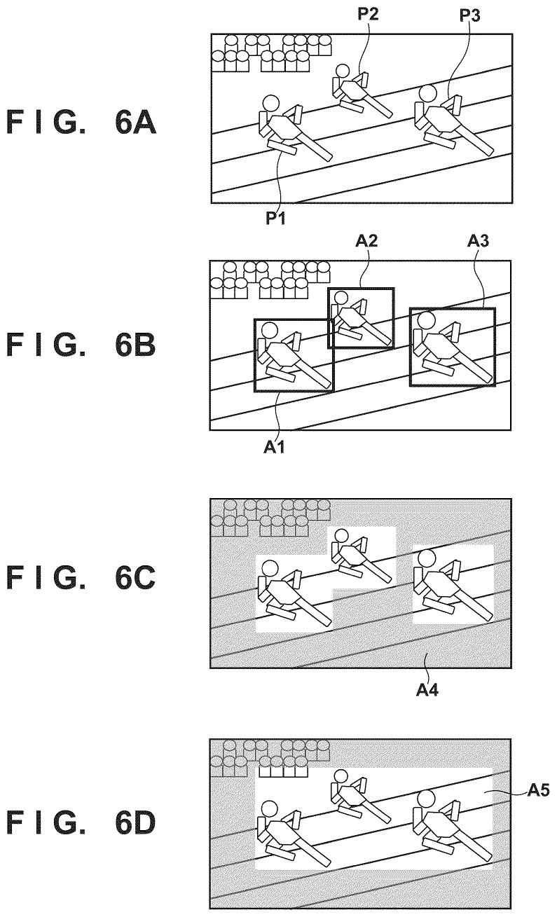

FIGS. 6A to 6D schematically illustrate an example of editing processing that may be applied in a case where “sports” is set as the scene in the scene selection mode. FIG. 6A illustrates an image of image data for display before editing, and FIGS. 6B to 6D illustrate images of image data for display after editing.

In a case where “sports” is set in the scene selection mode, it can be assumed that the user intends to capture images of a sports scene. In this case, the image processing unit 24 determines an area of moving human subjects as a characteristic area to be emphasized and applies editing processing to emphasize the characteristic area.

Specifically, the image processing unit 24 detects a person area as a characteristic area and compares it to one previous detection result (for example, the detection result of the live view image of one frame previous) to identity a moving person area. Then, the image processing unit 24 applies editing processing to the live view image of the current frame to emphasize the moving person area.

Here, in the image of the current frame illustrated in FIG. 6A, moving person areas P1, P2, and P3 are detected. FIG. 6B illustrates an example of, as an example of editing processing to emphasize the person areas P1 to P3, processing being applied to superimpose frames A1 to A3 around the person areas.

FIG. 6C illustrates an example of, as an example of editing processing to emphasize the person areas P1 to P3, processing being applied to decrease the brightness of another area A4 without changing the display of the areas surrounding the person areas P1 to P3. FIG. 6D illustrates an example of, as an example of editing processing to emphasize the person areas P1 to P3, processing being applied to decrease the brightness of another area without changing the display of a rectangular area A5 surrounding all of the person areas P1 to P3.

In this manner, by detecting a characteristic area corresponding to a set type of scene or main subject and applying editing processing to emphasize the detected characteristic area, it can be expected that the user can more easily find the intended main subject. Since the user can more easily find the intended main subject, an effect of reducing the time taken for the user to move their line-of-sight to gaze at the main subject can be expected.

Note that editing processing to emphasize a characteristic area is not limited to the example described above. For example, the editing processing may emphasize the edges of the person areas P1, P2, and P3 detected as characteristic areas. Also, the frames A1 to A3 may be made to flash or displayed in a specific color. Also, in FIGS. 6C and 6D, instead of decreasing the brightness, a monochrome display may be used. In a case where the characteristic area is a person or animal area, the person or animal may be emphasized by converting the entire image into a thermographic pseudo-color image.

### Second Example

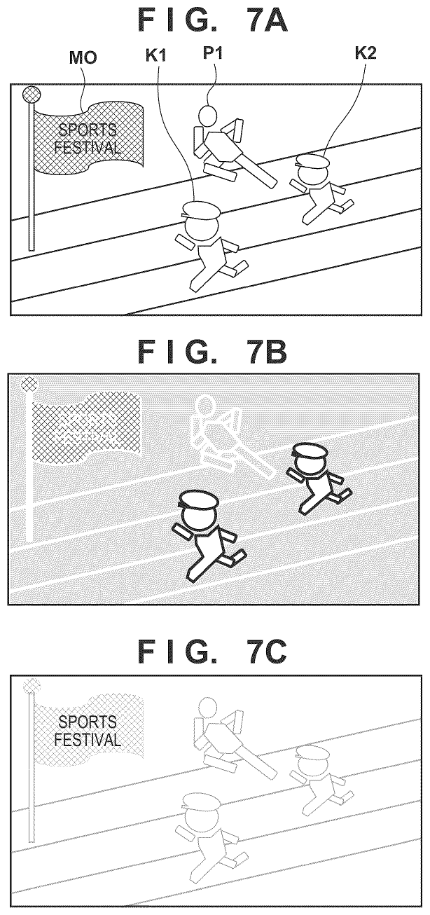

FIGS. 7A and 7B schematically illustrate an example of editing processing that may be applied in a case where “kids” is set as the main subject in the scene selection mode. FIG. 7A illustrates an image of image data for display before editing, and FIG. 7B illustrates an image of image data for display after editing.

In a case where “kids” is set in the scene selection mode, it can be assumed that the user intends to capture images of children as the main subject. In this case, the image processing unit 24 determines the area of human subjects assumed to be children as a characteristic area to be emphasized and applies editing processing to emphasize the characteristic area.

Whether a person area detected as a characteristic area is an adult or a child can be determined by, but is not limited to, using machine learning or by determining that the area is a child if the ratio of the length of the head to the length of the torso or height is equal to or less than a threshold, for example. Facial authentication may be used in advance to detect people registered as children.

In the image of the current frame illustrated in FIG. 7A, person areas P1, K1, and K2 are detected, and the areas K1 and K2 are determined to be children. Also, FIG. 7B illustrates an example of, as an example of editing processing to emphasis the children areas K1 and K2, processing being applied to emphasize the edges of the children areas K1 and K2 and decrease the grayscale of the areas other than the children areas K1 and K2. Decreasing the grayscale may be performed by, but at not limited to, reducing the maximum brightness (brightness compression), by reducing the number of brightness grayscales (from 256 gray levels to 16 gray levels), or the like. Brightness reduction or monochrome display as performed in the first example may be applied.

### Third Example

FIGS. 7A and 7C schematically illustrate an example of editing processing that may be applied in a case where “characters” is set as the main subject in the scene selection mode. FIG. 7A illustrates an image of image data for display before editing, and FIG. 7C illustrates an image of image data for display after editing.

In a case where “characters” is set in the scene selection mode, it can be assumed that the user intends to capture images focusing on the characters in the scene. In this case, the image processing unit 24 determines the area assumed to have characters as a characteristic area to be emphasized and applies editing processing to emphasize the characteristic area.

Here, in the image of the current frame illustrated in FIG. 7A, a character area MO is detected. Also, FIG. 7C illustrates an example of, as an example of editing processing to emphasis the character area MO, processing being applied to emphasize the edges of the character area MO and to decrease the grayscale of the areas other than the character area MO. The grayscale reduction method may be similar to that used in the second example.

As described in the second and third example, different editing processing may be applied to the same original image (FIG. 7A) depending on the set image capturing mode. Note that in the second and third example, editing processing similar to that used in the first example may be applied. Also, only one of edge emphasis of areas to be emphasize and brightness or grayscale reduction of other areas may be applied.

In the present embodiment, the editing processing that may be applied to image data for position of gaze detection is editing processing in which the area (characteristic area) to be emphasized determined on the basis of the setting information of the image capture apparatus is visually emphasized more than other areas. Editing processing may be any one of the four following processing, for example:
(1) processing in which an area to emphasize is not edited and other areas are edited to make them less noticeable (via brightness or grayscale reduction or the like),
(2) processing in which an area to emphasize is emphasized (edge emphasis or the like) and other areas are not edited,
(3) processing in which an area to emphasize is emphasized (edge emphasis or the like) and other areas are edited to make them less noticeable (via brightness or grayscale reduction or the like,
(4) processing in which the entire image is edited and an area to be emphasized is emphasized (conversion to pseudo color image or the like.

Note that these are merely examples, and any editing processing in which an area to be emphasized is visually emphasized (made more noticeable) over other areas can be applied.

Returning to FIG. 4, in S5, the system control circuit 50 displays the image data for display generated by the image processing unit 24 in S4 on the display unit 28. Also, the system control circuit 50 obtains, from the image processing unit 24, the rotation angle of the optical axis of the eyeball detected by the image processing unit 24 on the basis of the image for line-of-sight detection from the line-of-sight input unit 701. The system control circuit 50 obtains the coordinates (position of gaze) in the image displayed on the display unit 28 of where the user is gazing on the basis of the obtained rotation angle. Note that the system control circuit 50 may notify or give feedback to the user regarding the position of gaze by superimposing a mark or the like indicating the obtained position of gaze on a live view image.

Then, the position of gaze detection operation ends. The position of gaze obtained via the position of gaze detection operation can be used in setting the focus detection area, selecting the main subject, or the like but is not limited thereto. Note that when recording the image data obtained via image capture, information on the position of gaze detected at the time of image capture may be record in association with the image data. For example, information on the position of gaze at the time of image capture can be recorded as attachment information stored in the header or the like of the data file storing the image data. Information on the position of gaze recording in association with the image data can be used in identifying the main subject or the like in an application program or the like that handles the image data.

Note that in a case where the line-of-sight input function is not set to on, editing processing for assisting line-of-sight input is not applied to the image data for display by the image processing unit 24, but other target editing processing may be applied.

As described above, in the present embodiment, editing processing to visually emphasize a characteristic area determined on the basis of the setting information of the image capture apparatus more than other areas is applied to an image displayed when the line-of-sight input is on. Accordingly, an effect of making the area with a high possibility of being the intended main subject of the user more visually noticeable and reducing the time taken to gaze at the main subject can be expected.

Note that in the present embodiment, the area to be emphasized is determined on the basis of the image capturing mode setting. However, if the type of main subject with a high possibility of being intended by the user can be determined, other settings may be used.

### Second Embodiment

Next, the second embodiment will be described. The second embodiment is an embodiment in which XR goggles (a head-mounted display apparatus or HMD) is used as the display unit 28 of the first embodiment. Note that XR is a collective term for VR (virtual reality), AR (augmented reality), and MR (mixed reality).

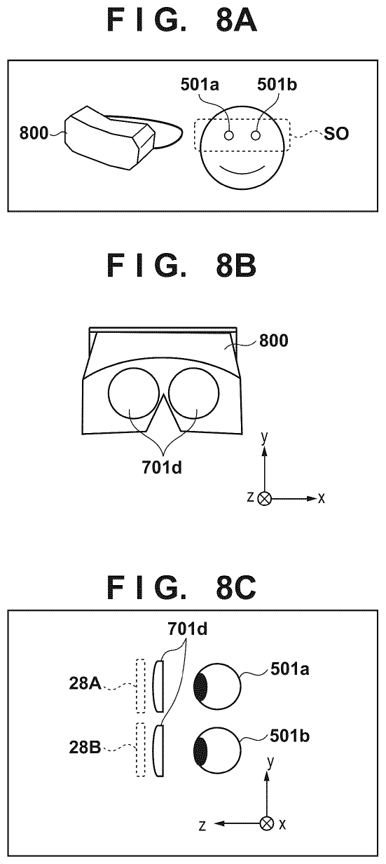

The left diagram in FIG. 8A is a perspective view illustrating the external appearance of XR goggles 800. The XR goggles 800 are typically mounted on an area SO of the face illustrated in the right diagram of FIG. 8A. FIG. 8B is a diagram schematically illustrating a mounting surface (surface that comes into contact with the face) of the XR goggles 800. Also, FIG. 8C is a top view schematically illustrating the positional relationship between the eyepiece lens 701d and display units 28A and 28B of the XR goggles 800 and a right eye 501a and left eye 501b of the user when the XR goggles 800 are mounted.

The XR goggles 800 including the display unit 28A for the right eye 501a and the display unit 28B for the left eye 501b, and by displaying a right eye image on the display unit 28A and a left eye image on the display unit 28B, which form a pair of parallax images, three-dimensional vision can be achieved. Thus, the eyepiece lens 701d described in the first embodiment is provided on both the display unit 28A and the display unit 28B.

Note that in the present embodiment, the image capture unit 22 includes pixels with the configuration illustrated in FIG. 2A. In this case, a right eye image can be generated from the pixel signal group obtained from the photoelectric conversion unit 201a, and a left eye image can be generated from the pixel signal group obtained from the photoelectric conversion unit 201b. The right eye image and the left eye image may be generated with a different configuration, such as the lens unit 150 including a lens that enables stereo video to be captured. Also, the line-of-sight input unit 701 is provided on the eyepiece unit of the XR goggles, and an image for line-of-sight detection is generated for the right eye or the left eye.

Other configurations can be implemented using similar configurations to the image capture apparatus 1 illustrated in FIG. 1 and thus will be described below using the components of the image capture apparatus 1. Note that in the present embodiment, instead of a live view image, an image for display is generated using a right eye image and a left eye image recorded in advance in the recording medium 200.

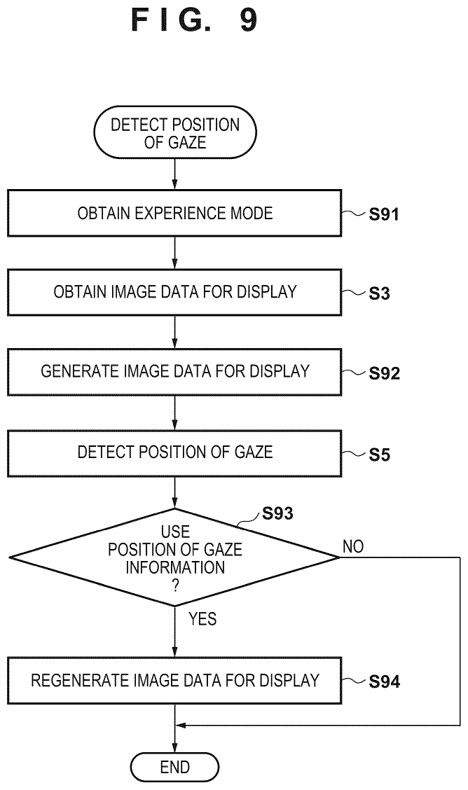

FIG. 9 is a flowchart relating to the position of gaze detection operation according to the present embodiment. Steps for executing processing similar to that in the first embodiment are given the same reference sign as in FIG. 4, and redundant description will be omitted.

In S91, the system control circuit 50 obtains the currently set experience mode. In the present embodiment, image capture is not performed, and an experience mode relating to XR is obtained. The experience mode is a type of virtual environment where XR is experienced, for example. Options including “art gallery”, “museum”, “zoo”, and “diving” are prepared. Note that the experience mode can be set via a method including using a remote controller, using an input device provided on the XR goggles, by selecting from a displayed menu via line-of-sight, and the like. Note that the recording medium 200 stores image data for display corresponding to each virtual environment that can be selected as the experience mode.

In S3, the system control circuit 50 reads out from the recording medium 200 and obtains the image data for display corresponding to the experience mode selected in S91 and then supplies the image data for display to the image processing unit 24.

In S92, the image processing unit 24 applies editing processing to the image data for display supplied from the system control circuit 50 and generates image data for display for position of gaze detection. In the present embodiment, since the image data for display is stereo image data including a right eye image and a left eye image, the image processing unit 24 applies editing processing to both the right eye image and the left eye image.

In S92, the editing processing that is applied by the image processing unit 24 is editing processing in which the characteristic area determined on the basis of the setting information (in this example, the experience mode) of the apparatus providing the XR experience (in this example, the image capture apparatus 1) is visually emphasized more than other areas. Via this editing processing, an effect of increasing the immersion of the XR experience can be expected.

Next, an example of editing processing that is applied by the image processing unit 24 in S92 will be described.

### Fourth Example

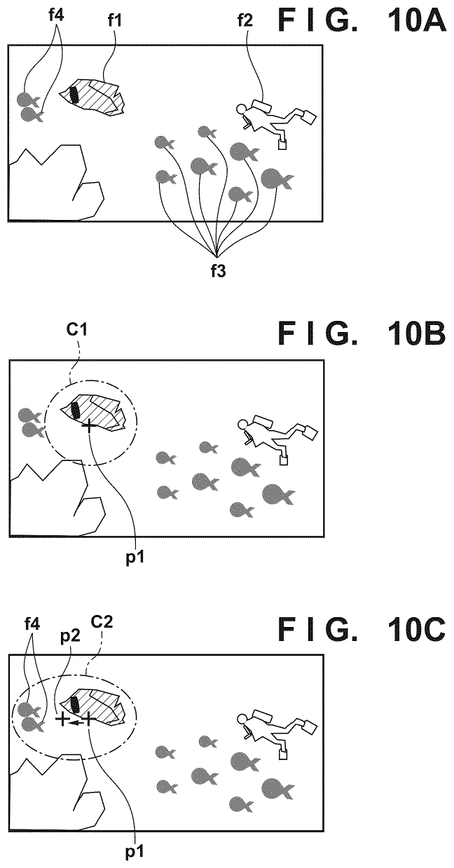

FIGS. 10A to 10C schematically illustrate an example of editing processing that may be applied in a case where “diving” is set as the experience mode. FIG. 10A illustrates an image representing the image data for display before editing.

In a case where “diving” is set as the experience mode, it can be assumed that the user is interested in underwater living things. In this case, the image processing unit 24 determines an area of moving underwater living things as a characteristic area to be emphasized and applies editing processing to emphasize the characteristic area.

Specifically, the image processing unit 24 detects areas of fish, sea creatures, and the like as characteristic areas and compares them to a previous detection result to identity a moving characteristic area. Then, the image processing unit 24 applies editing processing to the frame image targeted for processing to emphasize the moving characteristic area.

Here, in the frame image targeted for processing illustrated in FIG. 10A, characteristic areas f1 to f4, which are areas of moving fish and a person, are detected. In this case, the image processing unit 24 applies, as editing processing to emphasis the characteristic areas f1 to f4, editing processing to maintain the display of the characteristic areas f1 to f4 and reduce the number of colors in other areas (for example, make monochrome). Note that the editing processing to emphasis the characteristic area may include that described in the first embodiment and other editing processing.

Returning to FIG. 9, in S5, the system control circuit 50 obtains, from the image processing unit 24, the rotation angle of the optical axis of the eyeball detected by the image processing unit 24 on the basis of the image for line-of-sight detection from the line-of-sight input unit 701. The system control circuit 50 obtains the coordinates (position of gaze) in the image displayed on the display unit 28A or 28B of where the user is gazing on the basis of the obtained rotation angle. Then, the system control circuit 50 displays, on the display units 28A and 28B, a mark indicating the position of gaze superimposed on the right eye image data and the left eye image data generated by the image processing unit 24 in S92.

In S93, the system control circuit 50 determines whether or not to apply further editing processing on the image for display using the position of gaze information detected in S5. This determination can be executed on the basis of any determination condition such as on the basis of a user setting relating to use of position of gaze information, for example.

The system control circuit 50 ends the position of gaze detection operation if it is determined to not use the position of gaze information. If it is determined to use the line-of-sight position information, the system control circuit 50 executes S94.

In S94, the system control circuit 50 reads out the image data for display stored in the video memory area of the memory 32 and supplies the image data for display to the image processing unit 24. The image processing unit 24 using the position of gaze detected in S5 and applies further editing processing to the image data for display.

FIGS. 10B and 10C illustrate examples of the editing processing using position of gaze information executed in S94. A marker P1 indicating the position of gaze detected in S5 is superimposed on the image data for display. Here, since a detected position of gaze p1 is within a characteristic area f1, there is a high possibility that the user is interested in the characteristic area f1. Thus, of the characteristic areas f1 to f4 emphasized by applying the editing processing in S92, the characteristic area f1 is visually emphasized more than the other characteristic areas f2 to f4 by applying editing processing.

For example, in S92, the characteristic areas f1 to f4 are maintained in a color display and other areas are displayed in monochrome to emphasize the characteristic areas f1 to f4. In this case, in S94, the image processing unit 24 displays the characteristic areas f2 to f4 also in monochrome and maintains the color display of the characteristic area f1 or an area including the position of gaze and the characteristic area (the characteristic area f1 in this example) closest to the position of gaze. FIG. 10B schematically illustrates a state in which an area C1 including the position of gaze p1 and the characteristic area f1 is maintained in a color display and other areas including the characteristic areas f2 to f4 are displayed in monochrome by executing editing processing. Here, the characteristic areas f2 to f4 are changed to the same display format as the areas other than the characteristic areas. However, the characteristic areas f2 to f4 may be displayed in a format that makes them less noticeable than the characteristic area f1 but more noticeable than the areas other than the characteristic areas.

In this manner, by narrowing down the characteristic areas to be emphasized using the position of gaze, compared to when not using the position of gaze, the characteristic area which the user is interested in can be more accurately found, and emphasize editing processing can be applied. Thus, an effect of increasing the immersion at the time of the XR experience can be further expected. Also, with the application using position of gaze, an effect of making it easy for the user to confirm they are gazing at the intended subject can be expected.

A change over time of the detected position of gaze can also be used. In FIG. 10C, p1 is the position of gaze detected at time T=0, and p2 is the position of gaze detected at time T=1 (any unit may be used). In this case, in the time from time T=0 to 1, the position of gaze has moved from p1 to p2. This shows that the line-of-sight of the user has moved in the left direction.

In this case, by emphasizing the characteristic area f4 that exists in the movement direction of the position of gaze, an effect of making it easier for the user to gaze at a new characteristic area can be expected. Here, C2 is an example of an expanded area with color display maintained that includes the characteristic area f4, which is the characteristic area with the shortest distance in the movement direction of the position of gaze. In this example, the area to be emphasized is expanded in the movement direction of the position of gaze, but the area may simply be moved to match the movement of the position of gaze and not be expanded.

In this manner, by determining the area to emphasize taking into account the change over time of the line-of-sight position, an effect of being able to emphasize the subject that the user will likely gaze at next and being able to assist the user to easily gaze at the desired subject can be expected.

Next, another example of editing processing that is applied by the image processing unit 24 in S92 will be described.

### Fifth Example

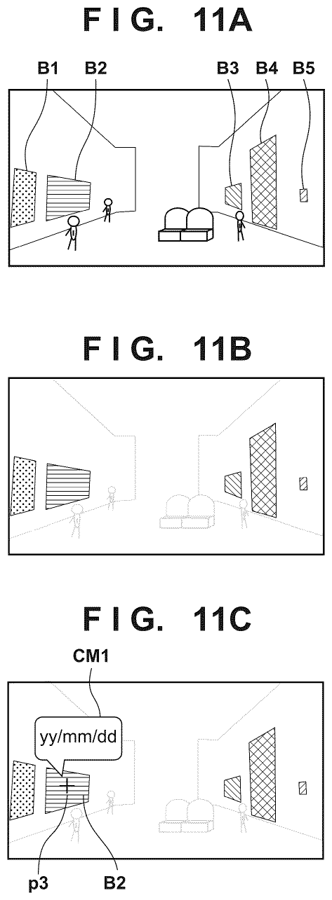

FIGS. 11A to 11C schematically illustrate an example of editing processing that may be applied in a case where “art gallery” is set as the experience mode. FIG. 11A illustrates an image representing the image data for display before editing.

In a case where “art gallery” is set as the experience mode, it can be assumed that the user is interested in pieces of art including paintings, sculptures, and the like. In this case, the image processing unit 24 determines an area of a piece of art as a characteristic area to be emphasized and applies editing processing to emphasize the characteristic area.

Here, in the frame image targeted for processing illustrated in FIG. 11A, characteristic areas B1 to B5, which are areas of pieces of art, are detected. In this case, in S92, as illustrated in FIG. 11B for example, the image processing unit 24 applies, as editing processing to emphasis the characteristic areas B1 to B5, editing processing to maintain the display of the characteristic areas B1 to B5 and reduce the brightness in other areas. Note that the editing processing to emphasis the characteristic area may include that described in the first embodiment and other editing processing.

In the case of applying further editing processing to the image for display using the position of gaze information, in S94, as illustrated in FIG. 11C for example, the image processing unit 24 can display the characteristic area B2 including the position of gaze (indicated by a marker p3) superimposed with prestored attached information CM1. The attached information CM1 is not particularly limited and may be information corresponding to the type of characteristic area, such as bibliographic information including the title of a painting, the artist, the creation date, and the like in the case of a painting. Note that in the present embodiment, the image data for display is prepared in advance. Thus, the information on the position of the piece of art in the image and the attached information on the piece of art can also be prepared in advance. Accordingly, the image processing unit 24 can identify the piece of art at the position of gaze and can obtain the corresponding attached information.

Here, attached information for a piece of art at the position of gaze is additionally displayed for further emphasis. However, another method of emphasizing may be used, including superimposing an enlarged image of the piece of art at the position of gaze, for example.

As described above, in the present embodiment, in addition to the editing processing described in the first embodiment, editing processing taking into account the position of gaze is applied. Thus, a characteristic area with a high possibility that the user is interested in it can be further effectively emphasized. Accordingly, the user can be assisted to quickly gaze at a desired subject, and a more immersive XR experience can be provided.

### Third Embodiment

Next, the third embodiment will be described. The line-of-sight input function is a function that uses the vision of the user. However, different users have different vision characteristics. Thus, in the present embodiment, editing processing taking into account the vision characteristics of the user is applied to the image data for display. This improves the user-friendliness of the line-of-sight input function.

Examples of individual differences in vision characteristics include:
(1) individual differences in the brightness range (dynamic range) in which differences in brightness can be distinguished,
(2) individual differences in the central vision (a range of 1° to 2° from the point of gaze and the effective field of view (a range from 4° to 20° from the point of the gaze),
(3) individual differences in the recognition capability of different hues, and the like. These individual differences may be innate or acquired (typically due to age).

Thus, in the present embodiment, vision information reflecting the individual differences of (1) to (3) are registered for each user, and by applying editing processing reflecting the vision information to the image data for display, a line-of-sight input function that is easily used by each user is provided.

A specific example of a calibration function for obtaining vision information will be described below. The calibration function can be executed by the system control circuit 50 in the case of a user issuing an instruction to execute via the menu screen, the vision characteristics of a user not being registered, or the like.

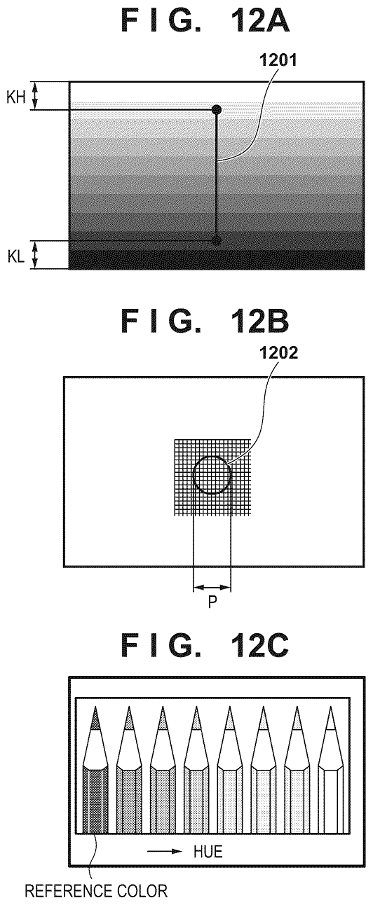

The brightness dynamic range of (1) can be the range from the maximum brightness to the minimum brightness that is not uncomfortable for the user. For example, as illustrated in FIG. 12A, the system control circuit 50 displays, on the display unit 28, an achromatic color gradation chart representing a predetermined number of gray levels from maximum brightness to minimum brightness. Then, the user can be made to select the brightness range that is not uncomfortable by operating the operation unit 70, for example. The user can adjust the upper end and the lower end of a bar 1201 using the up/down key of a 4-directional key, for example, and can set the maximum brightness that is not uncomfortably bright and the minimum brightness at which a difference with the adjacent gray level can be distinguished (or that is not felt to be too dark).

The system control circuit 50 registers brightness ranges KH and KL as ranges preferably not used for the user on the basis of the upper end position and the lower end position of the bar 1201 when the set (enter) button is pressed, for example. Note that the brightness corresponding to the upper end position and the lower end position of the bar 1201 may be registered.

Alternatively, the maximum brightness and the minimum brightness may be set by the user by the system control circuit 50 increasing the overall brightness of the screen in response to the up key of the 4-directional key being pressed and decreasing the overall brightness of the screen in response to the down key being pressed. Also, the system control circuit 50 may prompt the user to press the set button when the display is in a state of maximum brightness that is not uncomfortably bright. Then, the system control circuit 50 registers the display brightness when the set button press is detected as the maximum brightness. Also, the system control circuit 50 may prompt the user to press the set button when the display is in a state of minimum brightness at which a difference with the adjacent gray level can be distinguished (or that is not felt to be too dark). Then, the system control circuit 50 registers the display brightness when the set button press is detected as the minimum brightness. In this case also, instead of the maximum brightness and the minimum brightness, the brightness range KH on the high brightness side and the brightness range KL on the low brightness side that are preferably not used for the user may be registered.

The vision characteristics of the user relating to the brightness dynamic range can be used to determine whether or not brightness adjustment is required and to determine the parameters when adjusting brightness.

The effective field of view of (2) is a range including the central vision in which information can be discerned. The effective field of view may be the field of view referred to as the Useful Field of View (UFOV). As illustrated in FIG. 12B for example, the system control circuit 50 displays, on the display unit 28, an image displaying a circle 1202 with a variable size with a background of a relatively intricate pattern. Then, the user is prompted to adjust the size of the circle 1202 to a range at which the background pattern is clearly discernible while gazing at the center of the circle 1202. By adjusting the size of the circle 1202 using the up/down key of the 4-directional key to correspond to the maximum range at which the background pattern is clearly discernible and pressing the set key, for example, the size of the effective field of view can be set. The system control circuit 50 changes the size of the circle 1202 when a press of the up/down key is detected and, when a press of the set key is detected, registers the range of the effective field of view corresponding to the size of the circle 1202 at this time.

The vision characteristics of the user relating to the effective field of view can be used to extract the gaze range.

(3) is the size of the hue difference at which a difference in the same color can be distinguished. As illustrated in FIG. 12C, the system control circuit 50 displays, on the display unit 28, an image including a plurality of color samples arranged in a selectable manner with the hue of the same color gradually changing. Here, the displayed color samples can be colors that cover a large area of the background of the subject such as green, yellow, or blue, for example. Also, information on a plurality of colors such as green colors, yellow colors, blue colors may be obtained.

In FIG. 12C, the color samples are arranged using an image of color pencils. However, the color samples may be strips or the like. The color pencil on the left end is a reference color, and in the right direction, each color sample is arranged with the hue changing by a constant amount. The system control circuit 50 prompts the user to select, from among the color pencils, the leftmost color pencil that they can distinguish to be a different color to the color pencil on the left end. The user selects the corresponding color pencil using the left/right key of the 4-directional key, for example, and presses the set key. When a press of the left/right key is detected, the system control circuit 50 moves which color pencil is in the selected state, and when a press of the set key is detected, the system control circuit 50 registers the difference between the hue corresponding to the color pencil in the selected state at this time and the hue of the reference color as the minimum hue difference able to be discerned by the user. In a case where information on a plurality of colors is registered, the same operation is repeated for each color.

The vision characteristics of the user relating to the hue difference recognition capability can be used to determine whether or not hue adjustment is required and to determine the parameters when adjusting hue.

The individual differences, vision characteristics (1) to (3), and the method for obtaining user-specific information on the vision characteristics (1) to (3) described above are merely examples. User information on other vision characteristics can be registered, and/or another method can be used to register the information on the vision characteristics (1) to (3).

Next, a specific example of editing processing using the vision characteristics (1) to (3) of a registered user will be described. Note that in a case where the vision characteristics can be registered for a plurality of users, for example, the vision characteristics relating to a user selected via a settings screen is used.

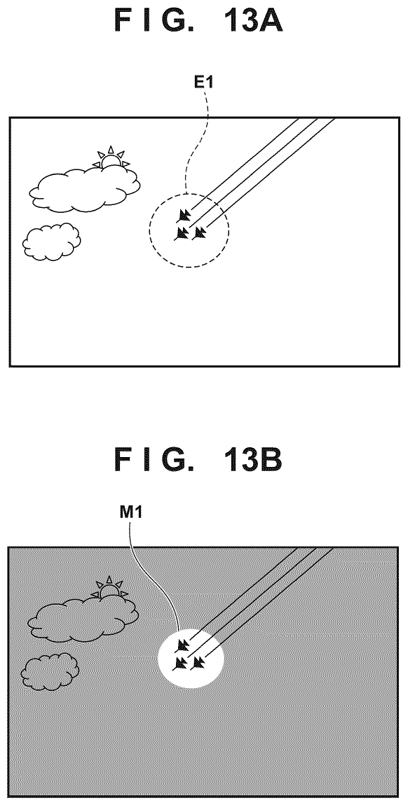

FIG. 13A illustrates a scene including a plurality of aircrafts E1 with a very bright sky as the background taken against the sun. In such a case with a very bright background, according to user vision characteristics, gazing at the aircrafts E1 is difficult because the background is too bright.

To cope with this situation, the image processing unit 24 can determine whether or not the brightness value (for example, average brightness value) of the background is appropriate to the vision characteristics (brightness dynamic range) of the user in the case of generating image data for display when the line-of-sight input function is on. The image processing unit 24 determines that the brightness is not appropriate to the vision characteristics of the user in a case where the brightness value of the background is outside of the brightness dynamic range of the user (when included in the brightness range KH in FIG. 12A). Then, the image processing unit 24 applies editing processing to the image data for display to reduce the brightness so that the brightness value of the background area of the image is included in the brightness dynamic range (the brightness range represented by the bar 1201 in FIG. 12A) of the user.

FIG. 13B schematically illustrates a state in which editing processing to reduce the brightness of the background has been applied. M1 denotes the main subject area. In the image, the area excluding the main subject area M1 is defined as the background area. Here, the image processing unit 24 separates, from the background area, an area with a size that includes a characteristic area (in this example, the aircrafts) within a certain range from the position of gaze of the user as the main subject area M1. Note that the size of the main subject area may be the size of the effective field of view of the user. Also, another method may be used to determine the main subject area based on the position of gaze of the user.

Note that in a case where editing processing is applied to adjust the brightness to a brightness appropriate for the brightness dynamic range of the user, the target brightness value can be appropriately set within the brightness dynamic range. For example, the median value of the brightness dynamic range may be used. Note that in the example described above, the editing processing includes adjusting (correcting) the brightness value of the background area. However, the brightness value of the main subject area may be adjusted in a similar manner. Note that in a case where the brightness is adjusted for both the background area and the main subject area, the visibility of the main subject area can be improved by making the target brightness of the main subject area higher than that of the background area.

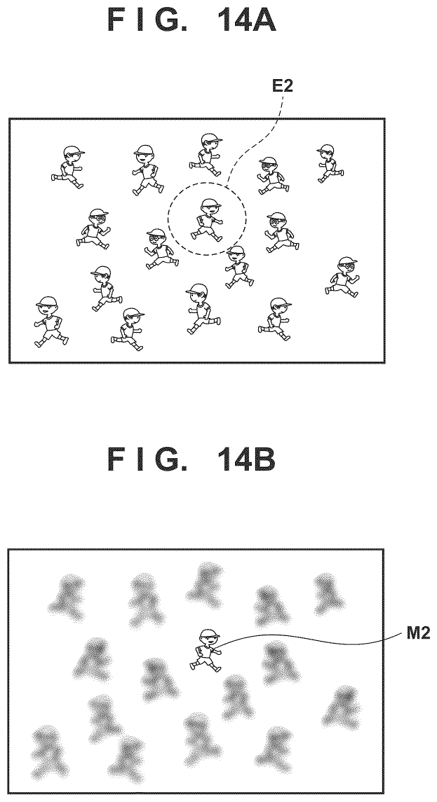

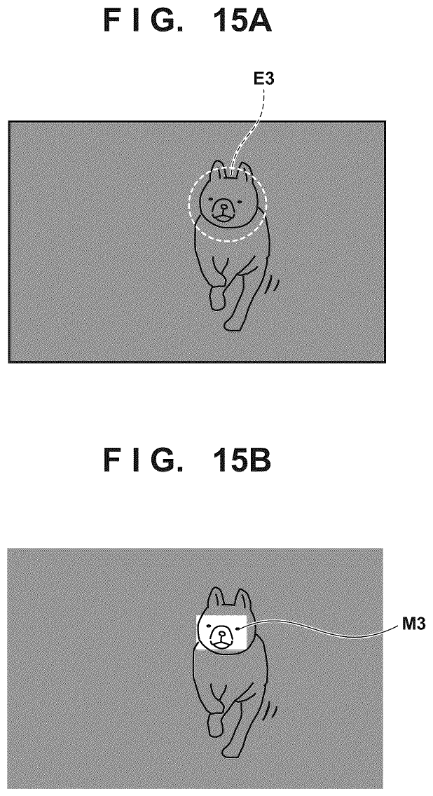

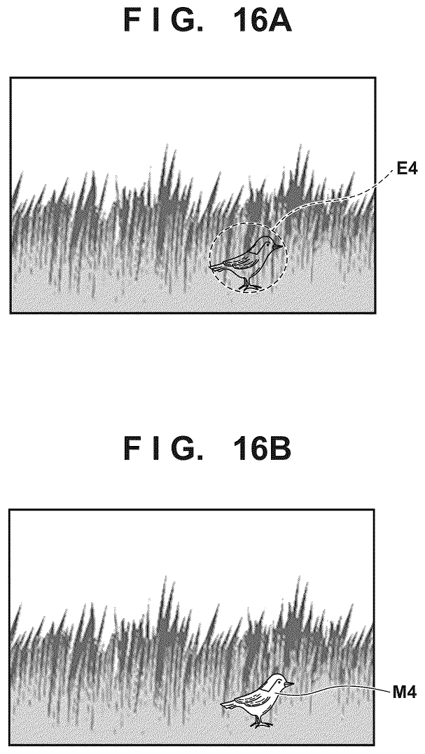

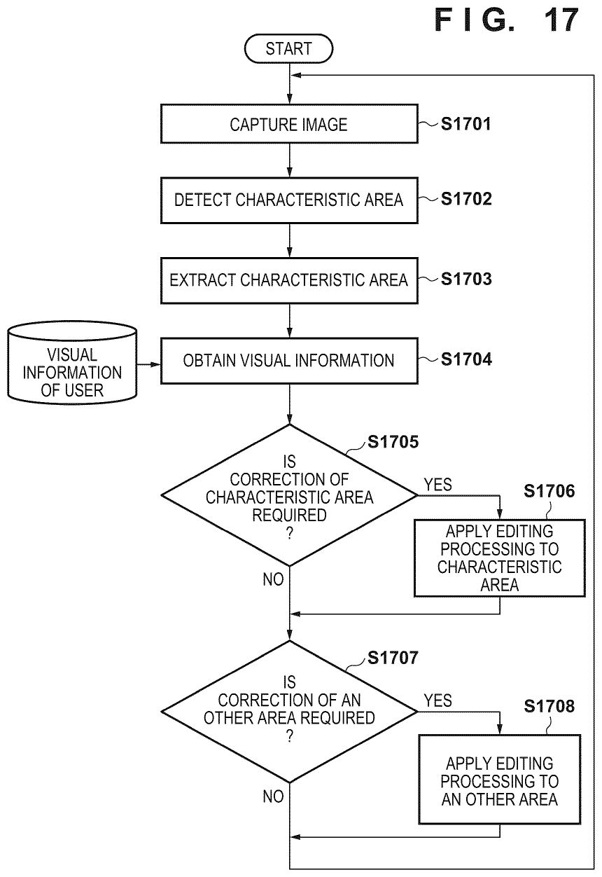

FIG. 14A illustrates, as a scene in which the main subject is easily lost sight of, a scene in which many similar subjects are moving in various directions such as at a team sport or during play. In FIG. 14A, the main subject intended by the user is denoted by E2.

When the user loses sight of the main subject E2 and the main subject strays outside of the effective field of view of the user, the main subject is perceived as blurry in a similar manner to the other subjects and so it is more difficult to make a distinction.

To cope with such a situation, as illustrated in FIG. 14B, the image processing unit 24 applies editing processing to reduce the resolution (blur) of the area (background area) other than a main subject area M2. Accordingly, the sharpness of the main subject area M2 is relatively increased, and even if the user loses sight of the main subject E2, the main subject E2 can be easily found. The main subject area M2 can be determined in a similar manner as in the method described relating to brightness adjustment.

Note that in a case where the size of the main subject area is greater than the central field of view, editing processing may be applied on the area outside of the range of the central field of view as the background area. In this manner, by relatively increasing the sharpness of the main subject, the user's attention can be naturally drawn to the main subject. Thus, an effect of assisting subject tracking based on the position of gaze can be achieved.

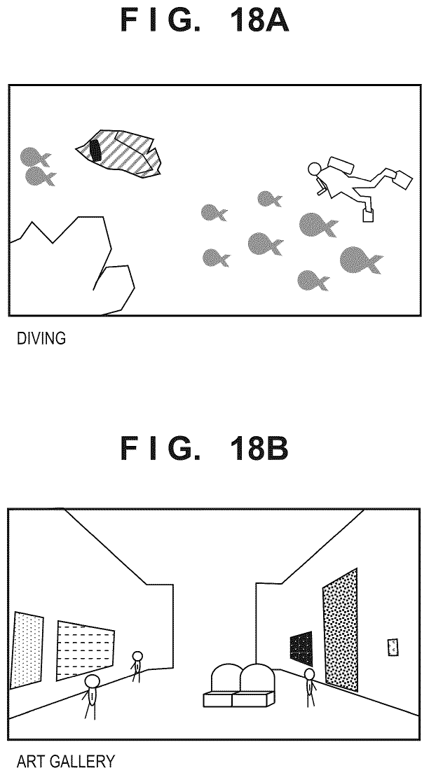

FIG. 15A illustrates, as an example of a scene in which the main subject is difficult to recognize due to the brightness of the main subject being low, a scene in which the main subject is an animal moving in a dark place. In FIG. 15A, the main subject intended by the user is denoted by E3.

To cope with this situation, the image processing unit 24 can determine whether or not the brightness value (for example, average brightness value) of the surrounding area of the position of gaze is appropriate to the vision characteristics (brightness dynamic range) of the user in the case of generating image data for display when the line-of-sight input function is on. The image processing unit 24 determines that the brightness is not appropriate to the vision characteristics of the user in a case where the brightness value of the surrounding area of the position of gaze is outside of the brightness dynamic range of the user (when included in the brightness range KL in FIG. 12A). Then, the image processing unit 24 applies editing processing to the image data for display to increase the brightness so that the brightness value of the surrounding area of the position of gaze is included in the brightness dynamic range (the brightness range represented by the bar 1201 in FIG. 12A) of the user. FIG. 15B schematically illustrates a state in which editing processing to increase the brightness of the surrounding area M3 of the position of gaze has been applied. Note that the surrounding area of the position of gaze may be an area corresponding to the effective field of view, a characteristic area including the position of gaze, an area used as a template for tracking, or the like, for example.

Here, the brightness of only the surrounding area of the position of gaze and not the overall image is adjusted (increased) because if the brightness of an image of a dark scene is increased, a noise component may degrade the visibility of the image. If the brightness of the entire screen is increased, the detection accuracy of a subject moving across frames may be degraded by the effects of noise. Also, if noise is noticeable in the entire screen, the flickering of noise tends to make the eyes of the user look tired.

Note that when a scene is dark, it is sufficiently plausible to think that the position of gaze is not on the main subject. Thus, the brightness of the entire screen may be increased until the position of gaze stabilizes, and after the position of gaze stabilizes, the brightness of the area other than the surrounding area of the position of gaze may be returned to the original level (not applying editing processing). If the movement amount of the position of gaze is equal to or less than a threshold over a certain amount of time, for example, the system control circuit 50 can determine that the position of gaze has stabilized.

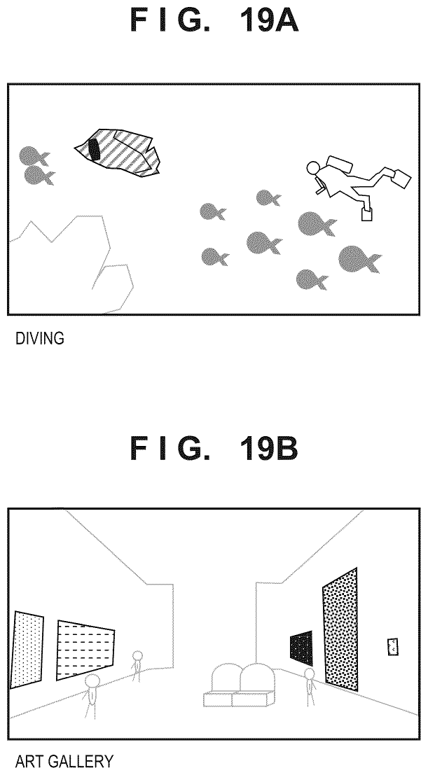

FIG. 16A illustrates, as an example of a scene in which the main subject is easily lost sight of due to the main subject and the background being a similar color, a scene in which a bird E4 of a similar color to the grass background is moving. In FIG. 16A, the main subject intended by the user is the bird E4. If the user loses sight of the bird E4, the background and the bird E4 having a similar color makes the bird E4 hard to find.

Thus, the image processing unit 24 can determine whether or not the difference between the hue of the main subject area (the area of the bird E4) and the hue of the background area surrounding at least the main subject is appropriate taking into account the hue difference recognition capability of the user from among the vision characteristics. Then, if the difference in hue between the main subject area and the background area is equal to or less than a difference in hue that the user can recognize, the image processing unit 24 determines that it is not appropriate. In this case, the difference in hue between the main subject area and the surround background area is increased to beyond the difference in hue that the user can recognize by the image processing unit 24 applying editing processing to change the hue of the main subject area to the image data for display. FIG. 16B schematically illustrates a state in which editing processing to change the hue of a main subject area M4 has been applied.

Note that the editing processing is not limited to that described here, and editing processing that uses the vision characteristics of the user can be applied. Also, a combination of editing processing can be combined according to the brightness and hue of the main subject area and the background area.

FIG. 17 is a flowchart relating to generation operations for image data for display according to the present embodiment. These operations can be executed in parallel with position of gaze detection when the line-of-sight input function is on.

In S1701, the system control circuit 50 captures an image of one frame via the image capture unit 22 and supplies a digital image signal to the image processing unit 24 via the A/D converter 23.

In S1702, the image processing unit 24 detects a characteristic area corresponding to the main subject area on the basis of the most recently detected position of gaze. Here, the image processing unit 24 may set the main subject area as the characteristic area including the position of gaze or the characteristic area with the shortest distance from the position of gaze after detecting a characteristic area of the type determined from the image capturing mode as described in the first embodiment.

In S1703, the image processing unit 24 extracts the characteristic area (main subject area) detected in S1702. In this manner, the main subject area and the other area (background area) are separated.

In S1704, the image processing unit 24 obtains information on the vision characteristics of the user stored in the non-volatile memory 56, for example.

In S1705, the image processing unit 24 calculates the difference in the average brightness or hue for the main subject area and the background area. Then, the image processing unit 24 determines whether or not to apply the editing processing on the main subject area by comparing the calculated difference in the average brightness or hue and the vision characteristics of the user. As described above, in a case where the difference in the brightness of the main subject or the difference in hue between the main subject area and the background area is not appropriate for the vision characteristics of the user, the image processing unit 24 determines that it is necessary to apply the editing processing to the main subject area. If the image processing unit 24 determines that it is necessary to apply the editing processing to the main subject area, S1706 is executed. Otherwise, S1707 is executed.

In S1706, the image processing unit 24 applies editing processing according to the content determined to be inappropriate to the main subject area, and then S1707 is executed.

In S1707, as in S1705, the image processing unit 24 determines whether or not it is necessary to apply the editing processing to the other area (background area). If the image processing unit 24 determines that it is necessary to apply the editing processing to the background area, S1708 is executed. If the image processing unit 24 does not determine that it is necessary to apply the editing processing to the background area, S1701 is executed, and the operations for the next frame are started.

In S1708, the image processing unit 24 applies editing processing according to the content determined to be inappropriate to the background area, and then S1701 is executed.

Note that what kind of editing processing to apply to the main subject area and the background area can be predetermined according to what is inappropriate for the vision characteristics of the user. Thus, whether the editing processing is applied to only the main subject area, whether the editing processing is applied to only the background area, or whether the editing processing is applied to both the main subject area and the background area and the content of the processing to be applied are specified according to the determination result of S1705.

As described above, according to the present embodiment, when the line-of-sight input function is on, editing processing taking into account the vision characteristics of the user is applied to generate image data for display. Thus, an image data for display that is appropriate for the vision characteristics of each user can be generated, and a line-of-sight input function that is easier to use for the users can be provided.

Note that the editing processing that facilitates selection of the main subject by the line-of-sight described in the first embodiment and the editing processing for making the image appropriate for the vision characteristics of the user described in the present embodiment can be combined and applied.

### Fourth Embodiment

Next, the fourth embodiment will be described. The present embodiment relates to improving the visibility of the virtual space experienced when using XR goggles (a head-mounted display apparatus or HMD) with the components of the image capture apparatus 1 built-in. An image of the virtual space visually perceived through the XR goggles is generated by rendering pre-prepared image data for display for each virtual space according to the direction and orientation of the XR goggles. The image data for display may be prestored in the recording medium 200 or may be obtained from an external apparatus.

Here for example, display data for providing the experience mode of “diving” and “art gallery” in the virtual space is stored in the recording medium 200. However, the type and number of virtual spaces to be provided are not particularly limited.

FIGS. 18A and 18B schematically illustrate examples of the virtual space for providing the experience mode of “diving” and “art gallery”. Here, to facilitate description and understanding, the entire virtual space is represented by a CG image. Thus, the main subject to be displayed with emphasis is a part of the CG image. By emphasizing the display of the main subject included in the virtual space image, the visibility of the main subject can be improved. The main subject is set by the image capture apparatus 1 (the system control circuit 50) in at least the initial state. The main subject set by the image capture apparatus 1 may be changed by the user.

Note that as with a video see-through HMD for example, in the case of displaying a combined image with a virtual space image superimposed as CG on a captured image of real space, the main subject area (characteristic area) to be displayed with emphasis may be included in a real image part or may be included in a CG part.

FIGS. 19A and 19B are diagrams schematically illustrating examples of editing processing to emphasize the main subject being applied to the scenes illustrated in FIGS. 18A and 18B. Here, the main subject is emphasized by reducing the color saturation of areas other than the main subject to improve the visibility of the main subject. Note that another method may be used to emphasize the main subject with the editing processing.

The examples illustrated in FIGS. 19A and 19B are examples of editing processing in which the area of the main subject is not edited and other areas are edited to make them less noticeable. Other examples include editing processing in which the main subject is emphasized but other areas are not edited and editing processing in which the main subject is emphasized and other areas are made less noticeable. More examples include editing processing in which the entire image is edited to emphasize a target subject and editing processing in which the main subject area is emphasized via another method.

In the case of experiencing diving in a virtual space, plausibly, the main subject is a “living thing”. In the case of experiencing an art gallery in a virtual space, plausibly, the main subject is a display item (a painting, sculpture, or the like) or an object with characteristic color (in this example, a subject in rich colors). In other words, depending on the virtual space to be presented or the type of experience, the main subject to be displayed with emphasis may change.

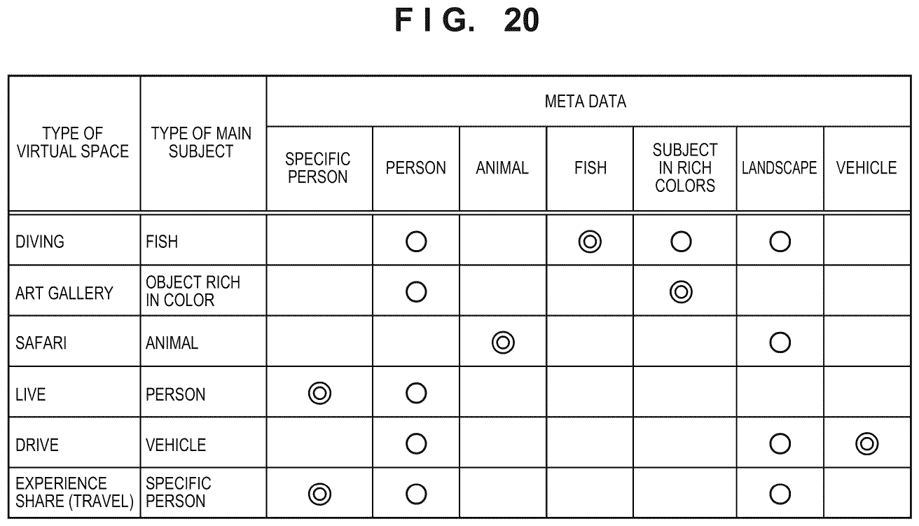

FIG. 20 is a diagram illustrating the relationship between the type of virtual space (or experience) to be provided and the type (type of characteristic area) of subject that can be displayed with emphasis. Here, the types of subjects that can be displayed with emphasis are associated with the types of virtual spaces as metadata. Also, the types of main subjects to be displayed with emphasis are by default associated with the types of virtual spaces. Here. the types of subjects displayed in a list as metadata correspond to the types of subjects that the image processing unit 24 can detect. Also, for each type of virtual space, types of subjects that can be set as the main subject are marked with a ○, and types of subjects that are selected as a main subject by default are marked with a ⊚. Thus, the user can select a new main subject from the subjects marked with a ○.

The method for the user to change the type of the main subject is not particularly limited. For example, in response to an operation of a menu screen via the operation unit 70, for example, the system control circuit 50 displays a GUI for changing the main subject on the display unit 28 of the image capture apparatus 1 or the display unit of the XR goggles. Then, the system control circuit 50 can change the settings of the main subject with respect to the type of the virtual space currently being provided in response to the operation of the GUI via the operation unit 70.

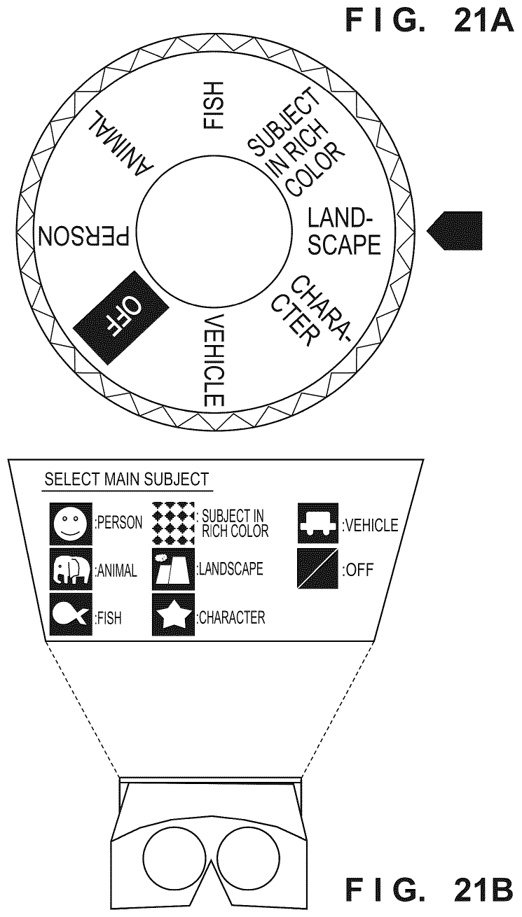

FIGS. 21A and 21B are diagrams illustrating examples of GUIs displayed for changing the main subject. FIG. 21A is a GUI imitating a mode dial. The main subject can be set to one of the options by operating a dial included on the operation unit 70. FIG. 21A illustrates a state in which the main subject is set to landscape. Note that the options displayed on the GUI for changing the main subject correspond to the types of metadata marked with a ○ in FIG. 20. Note that in the example of FIG. 21A, an option “OFF” is included in addition to the types of metadata for setting the emphasis display to not be performed. FIG. 21B illustrates another example of a GUI for changing the type of the main subject. This GUI is the same as the GUI illustrated in FIG. 21A except that, instead of imitating a dial, a list is displayed. By the user selecting the desired option using the operation unit 70, the main subject to be displayed with emphasis can be changed (emphasis display can be turned to OFF). Note that an option can be selected using line-of-sight.

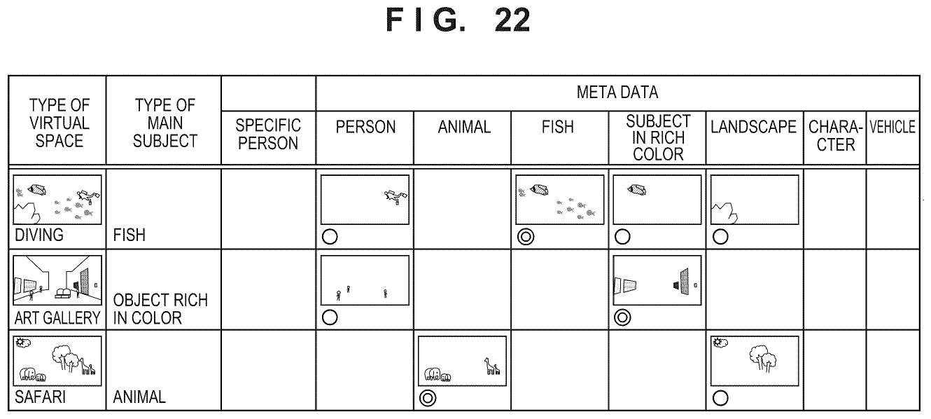

FIG. 22 is a diagram illustrating examples of metadata for the “diving”, “art gallery”, and “safari” type of virtual space as images. For example, for the virtual space images presented, the subject area detected by the image processing unit 24 for each type of subject can be extracted as metadata and stored in the memory 32. In this manner, changes to the main subject to be displayed with emphasis can be easily coped with. Note that in a case where the image of a virtual space to be displayed in XR goggles is pre-generated, the metadata can also be pre-recorded. Also, the metadata may be numerical value information (for example, the center position, the size, outer edge coordinate data, or the like) representing the subject area.

Also, the user can specify the type of the subject they are interested in using the position of gaze information described in the second embodiment, and a subject area of the specified type can be displayed with emphasis. In this case, since the type of the main subject to be displayed with emphasis changes according to the position of gaze, the user can change the main subject without explicitly changing the settings.

Also, in a case where there is no main subject in the current field of view or the number or size of the main subject area is equal to or less than a threshold, an indicator indicating the direction for putting more main subjects in the field of view may be superimposed on the virtual space image.

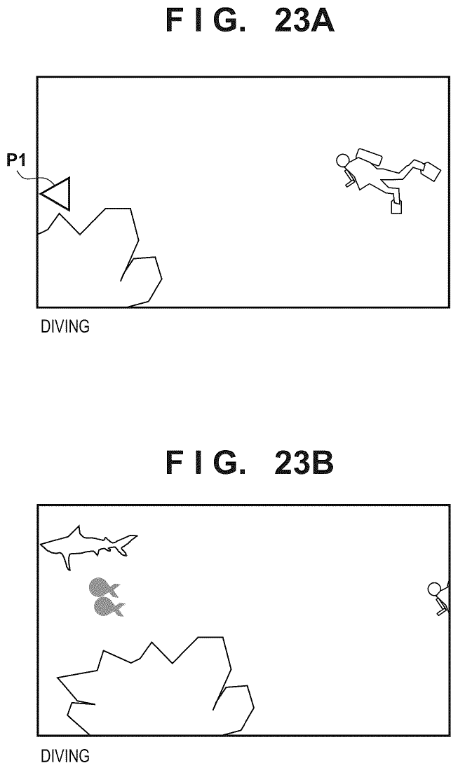

FIG. 23A illustrates an example of a virtual space image currently being presented on the XR goggles in a “diving” experience mode. In the presented virtual space image, there is no area of fish, a main subject. In this case, the system control circuit 50 can superimpose an indicator P1 indicating a direction where the main subject is found in the virtual space image. The system control circuit 50 can specify a direction for putting fish in the field of view of the XR goggles on the basis of position information of fish objects in the virtual space data for generating the image data for display, for example.

The user can turn their neck or the like to see in the direction indicated by the indicator P1 to visually perceive fish as illustrated in FIG. 23B. Note that a plurality of indicators indicating a direction where a main subject is found may be superimposed. In this case, the system control circuit 50 can perform a display so that an indicator indicating the direction with the shortest line-of-sight movement distance required to include the main subject in the field of view or an indicator indicating the direction that would allow the most number of main subjects to be included is made the most noticeable (increased in size).

According to the present embodiment, a subject area of a type according to the virtual space to be provided is displayed with emphasis. Accordingly, an effect of making the area with a high possibility of being the intended main subject of the user more visually noticeable in the virtual space image and reducing the time taken to gaze at the main subject can be expected.

### Fifth Embodiment

Next, the fifth embodiment will be described. The present embodiment relates to a display system that obtains a virtual space image to be displayed on the XR goggles as in the fourth embodiment from an apparatus such as a server external to the XR goggles.

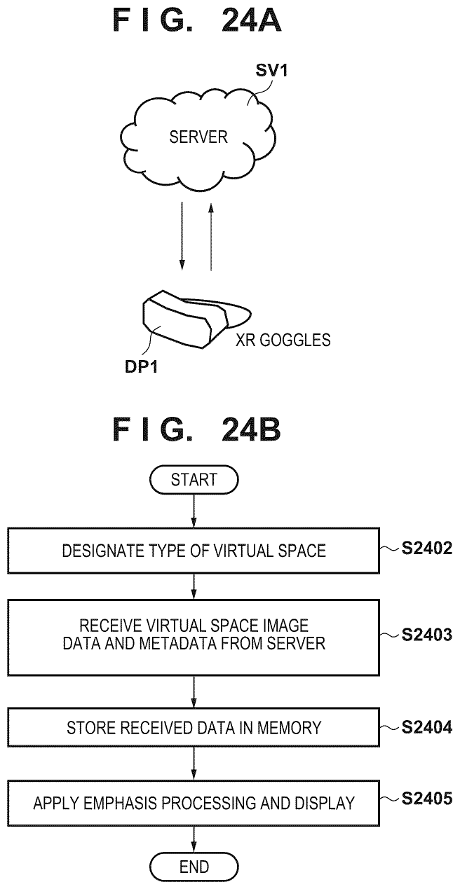

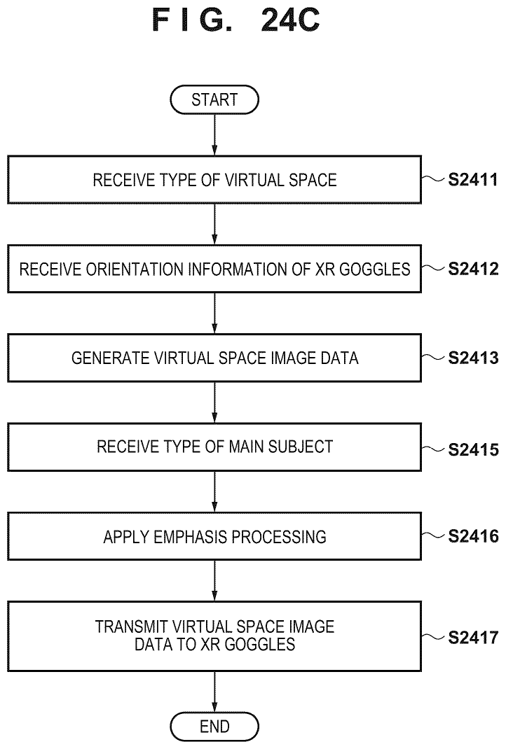

FIG. 24A is a schematic view of a display system in which XR goggles DP1 and a server SV1 are communicatively connected. A network such as a LAN or the Internet may exist between the XR goggles DP1 and the server SV1.

Typically, to generate a virtual space image, a large amount of virtual space data and the computational capability to generate (render) a virtual space image from the virtual space data is required. Thus, the information required to generate the virtual space image, such as the orientation information detected by the orientation detection unit 55 from the XR goggles, is output to the server. Then, a virtual space image to be displayed in the XR goggles is generated by the server and transmitted to the XR goggles.

By the virtual space data (three-dimensional data) being held by the server SV1, the same virtual space can be spared between a plurality of XR goggles connected to the server.

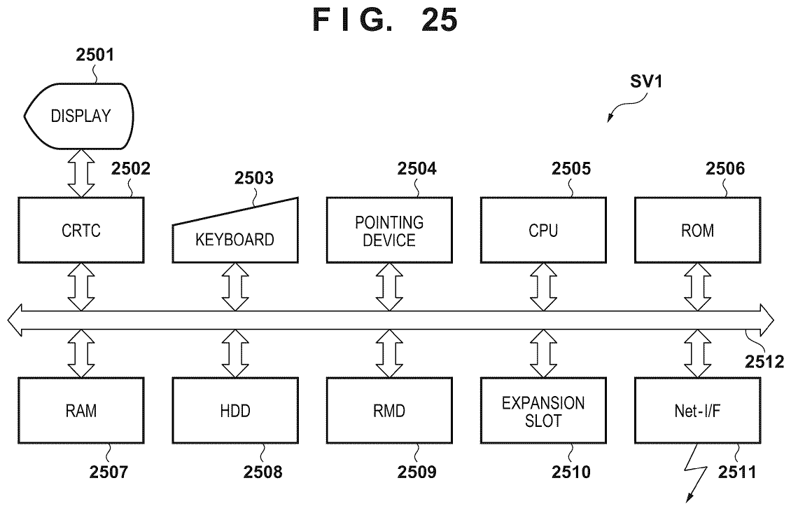

FIG. 25 is a block diagram illustrating an example configuration of a computer apparatus that can be used as the server SV1. In the diagram, a display 2501 is constituted by an LCD (Liquid Crystal Display) or the like and displays the information of data being processed by an application program, various types of message menus, and the like. A CRTC 2502 functioning as a video RAM (VRAM) display controller performs screen display control for the display 2501. A keyboard 2503 and a pointing device 2504 are used to input characters and the like, to operate icons and buttons on the GUI (Graphical User Interface), and the like. A CPU 2505 controls the entire computer apparatus.

ROM (Read Only Memory) 2506 stores programs executed by the CPU 2505, parameters, and the like. RAM (Random Access Memory) 2507 is used as the working area when the CPU 2505 executes various types of programs, as a buffer for various types of data, and the like.

A hard disk drive (HDD) 2508 and a removable media drive (RMD) 2509 function as external storage apparatuses. The removable media drive is an apparatus that reads from or writes to a detachable recording medium and may be an optical disk drive, a magneto-optical disk drive, a memory card reader, or the like.

Note that in addition to programs for implementing the various types of functions of the server SV1, an OS, application programs such as a browser, data, a library, and the like are stored in one or more of the ROM 2506, the HDD 2508, and (the recording medium of) the RMD 2509 depending on the application.

An expansion slot 2510 is a slot for expansion card installation compliant with the PCI (Peripheral Component Interconnect) bus standard, for example. A video capture board, a sound board, or other types of expansion boards can be installed in the expansion slot 2510.

A network interface 2511 is an interface for connecting the server SV1 to a local network or an external network. Also, the server SV1 includes one or more communication interfaces with an external device compliant with a standard other than the network interface 2511. Examples of other standards include USB (Universal Serial Bus), HDMI (High-Definition Multimedia Interface) (registered trademark), wireless LAN, Bluetooth (registered trademark), and the like.

A bus 2512 includes an address bus, a data bus, and a control bus and connects each blocks described above to one another.

Next, the operations of the server SV1 and the XR goggles DP1 will be described using the flowchart illustrated in FIG. 24B. The operations of the server SV1 are implemented by the CPU 2505 executing a predetermined application.

In S2402, a type (FIG. 20) of virtual space is designated from the XR goggles DP1 to the server SV1. The system control circuit 50 displays the GUI designated by the type of virtual space on the display unit 28 of the XR goggles DP1, for example. When a selection operation via the operation unit 70 is detected, the system control circuit 50 transmits data indicating the selected type to the server SV1 via the communication unit 54.

Here, the area of the virtual space displayed in the XR goggles DP1 is fixed. Thus, the server SV1 transmits image data (virtual space image data) of a specific scene of the virtual space of the designated type to the XR goggles DP1 together with attached metadata.

In S2403, the system control circuit 50 receives the virtual space image data and the attached metadata from the server SV1.

In S2404, the system control circuit 50 stores the virtual space image data and the metadata received from the server SV1 in the memory 32.

In S2405, the system control circuit 50 uses the image processing unit 24 to apply main subject area emphasis processing such as that described using FIGS. 19A and 19B to the virtual space image data. Then, the virtual space image data subjected to emphasis processing is displayed on the display unit 28. Note that in a case where the virtual space image is configured of a right eye image and a left eye image, emphasis processing is applied to each image.

FIG. 24C is a flowchart relating to the generation of virtual space image data according to the orientation (line-of-sight direction) of the XR goggles DP1 by the server SV1 and the operations of the server SV1 when emphasis processing is applied to the virtual space data. The operations of the server SV1 are implemented by the CPU 2501 executing a predetermined application.

In S2411, the server SV1 receives data designating a type of virtual space from the XR goggles DP1.

The operations from S2412 onward are executed for each frame of the video displayed in the XR goggles DP1.

In S2412, the server SV1 receives orientation information from the XR goggles DP1.

In S2413, the server SV1 generates virtual space image data according to the orientation of the XR goggles DP1. The virtual space data can be generated via any known method such as three-dimensional data rendering, extracting from a 360-degree image, and the like. For example, as illustrated in FIG. 26, the server SV1 can determine a display area of the XR goggles DP1 from the virtual space image on the basis of the orientation information of the XR goggles DP1 and extract an area corresponding to the display area. Note that the XR goggles DP1 may transmit information (for example, center coordinates) specifying the display area instead of orientation information.

In S2415, the server SV1 receives the type of the main subject from the XR goggles DP1. Note that the reception of the type of the main subject in S2415 is executed in a case where the type of the main subject is changed in the XR goggles DP1. If there is no change, this is skipped.

In S2416, the server SV1 applies main subject area emphasis processing to the virtual space image data generated in S2413. In a case where there is no change in the type of the main subject, the server SV1 applies emphasis processing to the default main subject area according to the type of the virtual space.

In S2417, the server SV1 transmits the virtual space image data subjected to the emphasis processing to the XR goggles DP1. In the XR goggles DP1, the received virtual space image data is displayed on the display unit 28.

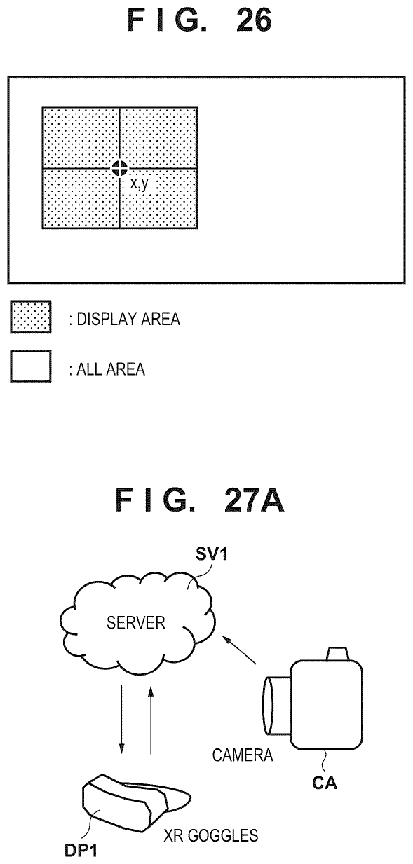

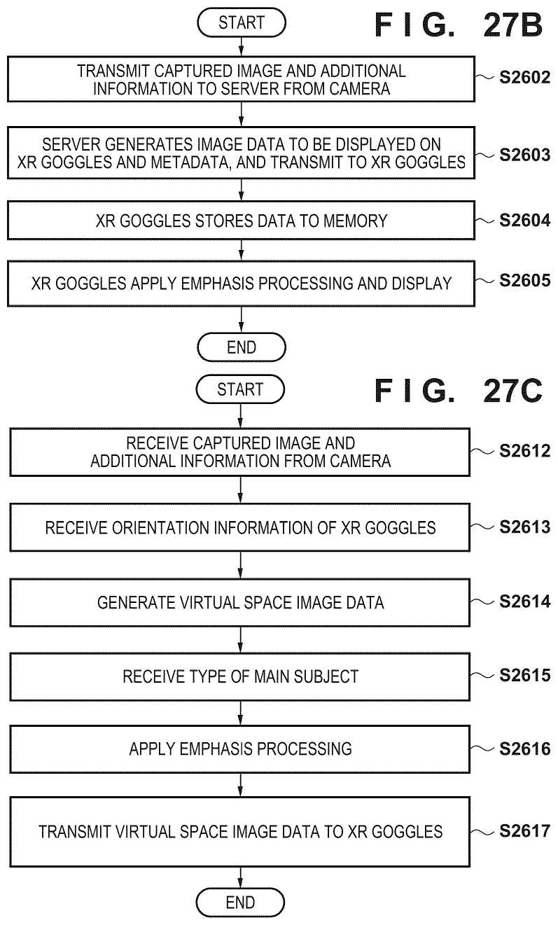

FIG. 27A is a schematic view of a display system with a camera CA that can generate VR images added to the configuration of FIG. 24A. Here, as the type of the virtual space, a case of the experience share given as an example in FIG. 20 is assumed. By displaying an image recorded with the camera CA with additional XR information in the XR goggles, a simulation of the experience of the user of the camera CA can also be experienced by the wearer of the XR goggles DP1.

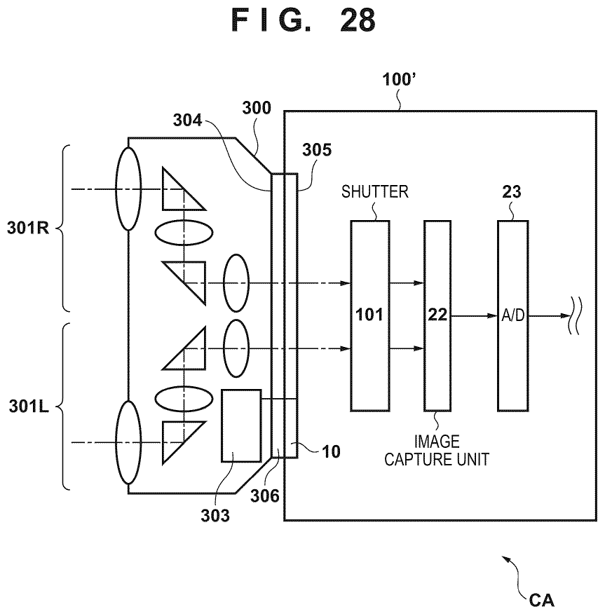

FIG. 28 is a block diagram illustrating an example configuration of the camera CA. The camera CA includes a body 100′ and a lens unit 300 mounted to the body 100′. The lens unit 300 and the body 100′ are attachable/detachable via lens mounts 304 and 305. Also, a lens system control circuit 303 included in the lens unit 300 and the system control circuit 50 (not illustrated) of the body 100′ can communicate with one another via communication terminals 6 and 10 provided on the lens mounts 304 and 305.

The lens unit 300 is a stereo fisheye lens, and the camera CA can capture a stereo circular fisheye image with a 180-degree angle of view. Specifically, each of two optical systems 301L and 301R of the lens unit 300 generate a circular fisheye image in which a 180-degree field of view in the left-and-right direction (horizontal angle, azimuth angle, yaw angle) and a 180-degree field of view in the up-and-down direction (vertical direction, elevation angle, pitch angle) are projected on a circular two-dimensional plane.

The body 100′ has a similar configuration to the body 100 of the image capture apparatus 1 illustrated in FIG. 1, though only a part of the configuration is illustrated here. The image (for example, moving image compliant with the VR180 standard) captured by the camera CA with such a configuration is recorded on the recording medium 200 as an XR image.

Next, the operations of the display system illustrated in FIG. 27A will be described using the flowchart illustrated in FIG. 27B. Note that the server SV1 is in a communicable state with the XR goggles DPI and the camera CA.

In S2602, image data is transmitted from the camera CA to the server SV1. Additional information including Exif information such as imaging conditions and the like, shooter line-of-sight information recorded at the time of image capture, main subject information detected at the time of image capture, and the like is attached to the image data. Note that instead of the camera CA and the server SV1 communicating, the recording medium 200 of the camera CA may be put in the server SV1 and the image data may be read out.

In S2603, the server SV1 generates image data to be displayed in the XR goggles DP1 and metadata from the image data received from the camera CA. In the present embodiment, since the camera CA records stereo circular fisheye images, the image data for display is generated by extracting a display area using a known method and converting it to a rectangular image. Also, the server SV1 detects a subject area of the predetermined type from the image data for display and generates information of the detected subject area as metadata. The server SV1 transmits the generated image data for display and the metadata to the XR goggles DP1. Also, the server SV1 transmits the additional information at the time of image capture such as the main subject information and the line-of-sight information obtained from the camera CA to the XR goggles DP1.

In S2604 and S2605, the operations performed by the system control circuit 50 of the XR goggles DP1 are similar to the operations of S2404 and S2405. Thus, this description will be skipped. The system control circuit 50 can determine the type of the main subject to be subjected to emphasis processing in S2605 on the basis of the main subject information received from the server SV1. Also, the system control circuit 50 may apply the emphasis processing to a main subject area specified on the basis of the shooter line-of-sight information. In this case, since the subject gazed at by the shooter at the time of image capture is displayed with emphasis, the experience of the shooter can be shared to a greater degree.

FIG. 27C is a flowchart relating to the operations of the server SV1 in the case of emphasis processing similar to that of FIG. 24C being executed by the server SV1 in the display system illustrated in FIG. 27A.

S2612 is similar to S2602, and thus this description is skipped.

Also, S2613 to S2617 are similar to S2412, S2413, and S2415 to S2417, and thus this description is skipped. Note that the type of the main subject to be displayed with emphasis is determined to be a designated type via a designation from the XR goggles DP1 or, if there is no designation, on the basis of the main subject information at the time of image capture.

According to the present embodiment, appropriate emphasis processing can be applied to virtual space images and VR images. Also, by a server or another external apparatus executing processing of heavy load, the resources required by the XR goggles can be reduced and sharing the same virtual space with a plurality of users can be made easy.

According to an aspect of the present invention, an image capture apparatus and a method for generating image data for display to assist a user to quickly gaze at an intended position or a subject can be provided.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image capture apparatus comprising:
one or more processors that execute a program stored in a memory and thereby function as:
a detecting unit configured to detect a position of gaze of a user in an image displayed by the image capture apparatus; and
a generating unit configured to generate image data for the display, wherein the generating unit:
for the image data generated when the detecting unit is on,
determines a type of a subject of a characteristic area on a basis of a setting of the image capture apparatus;
detects a subject of the determined type in the image and determines an area of the subject of the determined type as the characteristic area; and
applies editing processing to visually emphasize the characteristic area more than another area, and
for the image data generated when the detection unit is off, does not apply editing processing to visually emphasize the characteristic area more than another area.

2. The image capture apparatus according to claim 1, wherein the setting is a setting for image capture of a specific scene or a specific subject, and
the characteristic area is an area of a subject of a type according to the specific scene or an area of the specific subject.

3. The image capture apparatus according to claim 1, wherein the editing processing is any one of:
processing in which the characteristic area is not edited and another area is edited to make it less noticeable;
processing in which the characteristic area is emphasized and another area is not edited;
processing in which the characteristic area is emphasized and another area is edited to make it less noticeable; and
processing in which an entire image including the characteristic area is edited to emphasize the characteristic area.

4. The image capture apparatus according to claim 1, wherein the generating unit generates the image data as image data for a live view display.

5. The image capture apparatus according to claim 1, wherein the one or more processors further function as a setting unit configured to set a focus detection area on a basis of a position of gaze detected by the detecting unit.

6. The image capture apparatus according to claim 1, wherein the type of the subject is determined from a plurality of subject types including at least one of a human face, a human torso, a human limb, an animal face, a landmark, text, a vehicle, an aircraft, and a railway vehicle.

7. The image capture apparatus according to claim 1, wherein the setting is a scene,
the image capture apparatus further comprises a storage device in which a set scene and a type of subject corresponding to a characteristic area according to the set scene are stored with associated each other, and
the generating unit references information stored in the storage device to determine a type of subject of the characteristic area corresponding to the set scene.

8. A method executed by an image capture apparatus that is capable of detecting a position of gaze of a user in an image displayed, the method comprising:
generating image data for the display,
wherein the generating includes,
determining a type of a subject of a characteristic area on a basis of a setting of the image capture apparatus,
for the image data generated when the detection of the position of gaze is active,
detecting a subject of the determined type in the image and determines an area of the subject of the determined type as the characteristic area, and
applying editing processing to visually emphasize the characteristic area more than another area, and
for the image data generated when the detection of the position of gaze is inactive, not applying editing processing to visually emphasize the characteristic area more than another area.

9. A non-transitory computer-readable medium storing a program that causes, when executed by a computer included in an image capture apparatus, the image capture apparatus comprising:
a detecting unit configured to detect a position of gaze of a user in an image displayed by the image capture apparatus; and
a generating unit configured to generate image data for the display, wherein the generating unit:
for the image data generated when the detecting unit is on,
determines a type of a subject of a characteristic area on a basis of a setting of the image capture apparatus;
detects a subject of the determined type in the image and determines an area of the subject of the determined type as the characteristic area; and
applies editing processing to visually emphasize the characteristic area more than another area, and
for the image data generated when the detection unit is off, does not apply editing processing to visually emphasize the characteristic area more than another area.

10. An image processing apparatus, comprising:
one or more processors that execute a program stored in a memory and there by function as a generating unit configured to generate image data for display on a head-mounted display apparatus, wherein the generating unit generates the image data by applying editing processing to visually emphasize a characteristic area according to a type of a virtual environment provided to a user via the display apparatus more than another area.

11. The image processing apparatus according to claim 10, wherein the editing processing is any one of:
processing in which the characteristic area is not edited and another area is edited to make it less noticeable;
processing in which the characteristic area is emphasized and another area is not edited;
processing in which the characteristic area is emphasized and another area is edited to make it less noticeable; and
processing in which an entire image including the characteristic area is edited to emphasize the characteristic area.

12. The image processing apparatus according to claim 10, wherein the one or more processors further function as a detecting unit configured to detect a position of gaze of a user in an image displayed by the display apparatus, and
the generating unit generates the image data by, after the editing processing is applied, applying a further editing processing based on the position of gaze detected by the detecting unit.

13. The image processing apparatus according to claim 12, wherein the further editing processing is editing processing in which, of a plurality of the characteristic areas, a characteristic area including the position of gaze is visually emphasized more than another characteristic area.

14. The image processing apparatus according to claim 12, wherein the further editing processing is editing processing in which attached information on, of a plurality of the characteristic areas, a characteristic area including the position of gaze is superimposed and displayed.

15. The image processing apparatus according to claim 12, wherein the further editing processing is editing processing in which a characteristic area existing in a movement direction of the position of gaze is visually emphasized.

16. The image processing apparatus according to claim 10, wherein, for each type of virtual environment, a type of characteristic area that the editing processing can be applied to and a type of characteristic area that the editing processing is applied to by default are associated together.

17. The image processing apparatus according to claim 16, wherein the generating unit applies the editing processing on a basis of a type designated by a user from among types of characteristic areas associated with a virtual environment provided to the user.

18. The image processing apparatus according to claim 16, wherein, when there is no designation by a user, the generating unit applies the editing processing on a basis of a type of characteristic area that the editing processing is applied to by default associated with a virtual environment provided to the user.

19. The image processing apparatus according to claim 16, wherein the one or more processors further function as a detecting unit configured to detect a position of gaze of a user in an image displayed by the display apparatus, and
the generating unit applies the editing processing to a characteristic area based on the position of gaze detected by the detecting unit.

20. The image processing apparatus according to claim 16, wherein, in a case when the characteristic area is not included in the image data generated, the generating unit includes an indicator indicating a direction in which a characteristic area exists in the image data.

21. The image processing apparatus according to claim 16, wherein the head-mounted display apparatus is an external apparatus configured to communicate with the image processing apparatus.

22. The image processing apparatus according to claim 16, wherein the image processing apparatus is a part of the head-mounted display apparatus.

23. The image processing apparatus according to claim 16, wherein the one or more processors further function as an obtaining unit configured to obtain data of a VR image representing the virtual environment, and
the generating unit generates the image data from the VR image.

24. The image processing apparatus according to claim 23, wherein the obtaining unit further obtains main subject information and/or line-of-sight information obtained at a time of capturing the VR image, and
the generating unit determines the characteristic area to apply the editing processing to on a basis of the main subject information or the line-of-sight information.

25. An image processing method executed by an image processing apparatus, the method comprising:
generating image data for display on a head-mounted display apparatus, wherein the generating includes generating the image data by applying editing processing to visually emphasize a characteristic area according to a type of a virtual environment provided to a user via the display apparatus more than another area.

26. A non-transitory computer-readable medium storing a program that causes, when executed by a computer, the computer to function as an image capture apparatus comprising:
a generating unit configured to generate image data for display on a head-mounted display apparatus,
wherein the generating unit generates the image data by applying editing processing to visually emphasize a characteristic area according to a type of a virtual environment provided to a user via the display apparatus more than another area.
